(19) United States
(12) Patent Application Publication
(10) Pub. No.: US 2025/0335870 A1
(43) Pub. Date: Oct. 30, 2025

(54) SYSTEMS AND METHODS FOR GENERATING AND DYNAMICALLY APPLYING DIGITAL REPRESENTATIONS OF ITEMS WITHIN A WAREHOUSE ENVIRONMENT

(71) Applicant: Pattern Inc., Lehi, UT (US)

(72) Inventor: Robert Charles Hahn, Park City, UT (US)

(21) Appl. No.: 19/189,909

(22) Filed: Apr. 25, 2025

Related U.S. Application Data
(60) Provisional application No. 63/639,927, filed on Apr. 29, 2024.

(51) Int. Cl. G06Q 10/0875; G06Q 10/083

(52) U.S. Cl. CPC G06Q 10/0875; G06Q 10/0838

(57) ABSTRACT

Methods for conducting items from intake to outtake within a warehouse are described. A system that is configured to access information related to such items and their endpoint destinations and also to receive further information during processing enables the system to make data-driven decisions and provide corresponding tasks to associates within a warehouse or to machines such as conveyor belts within a warehouse. The system provides endpoint-to-endpoint knowledge, such that delays and errors which may occur within a warehouse are limited, as the system is configured to ensure that information is centralized rather than localized.

### CROSS REFERENCE TO RELATED APPLICATIONS

This U.S. Non-Provisional Patent Application claims the benefit of and priority to U.S. Provisional Patent Application Ser. No. 63/639,927, entitled “Systems and Methods for Managing Marketplace Item and Carton Preparation” and filed Apr. 29, 2024, the entire disclosure of which is hereby incorporated by reference in its entirety.

### TECHNICAL FIELD

The present disclosure relates generally to commerce systems and methods, and more specifically, to generating, maintaining, and managing a process flow of marketplace items within a warehouse setting or environment.

### BACKGROUND

Commerce systems are well known in the art and are effective means to allow for the transaction of products, commodities, services and the like from one party to another. Commonly, commerce systems are embodied by a market, where many products are offered for sale and people that are customers are able to shop or browse the products and select items for purchase. Such markets may be managed by companies that include eBay®, Amazon®, Wayfair®, Costco®, Walmart®, and Target®, among others. With the advent of digital marketplaces, sellers are allowed to list products for purchase to anyone with an internet connection. Commonly, many sellers will offer the same or similar products. Shoppers (e.g., users accessing digital marketplaces via the internet) are able to sort through and browse all of these products to find what they are looking for.

### SUMMARY OF THE DISCLOSURE

The various systems and methods of the present disclosure have been developed in response to the present state of the art, and in particular, in response to the problems and needs in the art that have not yet been fully solved by currently available digital marketplaces.

An aspect of the disclosed embodiments includes a system with web-based User Interface (UI), which is configured to enable associates, employees, workers, etc. to interact with the stored product data and to provide instructions to the associate about what is required to successfully complete the transaction. Moreover, such embodiments also pertain to a system that includes a user interface that guides the associates through the warehouse processes and gathers data to pass to the marketplace, in order to optimize logistical tasks in an efficient and repeatable manner. In some embodiments, the system may also be configured to combine instructions from work orders with product catalog data, such as marketplace prep instructions, in order to provide step-by-step instructions to the warehouse on how to handle items throughout the overall processing for marketplace shipping at various moments in time.

These and other aspects of the present disclosure are disclosed in the following detailed description of the embodiments, the appended claims, and the accompanying figures.

### BRIEF DESCRIPTION OF THE DRAWINGS

Exemplary embodiments of the disclosure will become more fully apparent from the following description and appended claims, taken in conjunction with the accompanying drawings. Understanding that these drawings depict only exemplary embodiments and are, therefore, not to be considered limiting of the scope of the disclosure, the exemplary embodiments of the disclosure will be described with additional specificity and detail through use of the accompanying drawings in which:

FIG. 1 is a schematic block diagram illustrating a system, according to the principles of the present disclosure;

FIG. 2A is a schematic block diagram illustrating a computing device in the form of the smartphone of FIG. 1, which is capable of practicing the principles of the present disclosure in a standalone computing environment;

FIG. 2B is a schematic block diagram illustrating a computing device in the form of the desktop computer of FIG. 1, and a server in the form of the first server of FIG. 1, which may cooperate to enable practice of the principles of the present disclosure with client/server architecture;

FIG. 3 is a schematic block diagram illustrating a computing device and a server in operating a digital marketplace, which may cooperate to enable practice of the principles of the present disclosure with client/server architecture;

FIG. 4 is a schematic block diagram illustrating a computing device and a server in hosting a digital marketplace that includes attributes of a target product and a competing product, which may cooperate to enable practice of the principles of the present disclosure with client/server architecture;

FIG. 5 is a schematic block diagram illustrating a computing device that includes a graphic user interface used to enable practice of the principles of the present disclosure within a client/server architecture;

FIG. 6 is a flowchart diagram illustrating a method of evaluating a product, according to one embodiment of the principles of the present disclosure;

FIG. 7 is a flowchart diagram illustrating a method of providing a competitive assessment of a target product on a marketplace, according to one embodiment of the principles of the present disclosure;

FIG. 8 is a schematic block diagram illustrating a computing device and a server in operating a digital marketplace, which may cooperate to enable practice of the principles of the present disclosure with client/server architecture;

FIG. 9 is a graphic representation of a plurality of search terms plotted at points that represent a frequency and similarities in search terms associated with a target product relative to competing products;

FIG. 10 is a graphic representation of a plurality of search terms plotted at points that represent relevance and volume of search terms associated with a target product relative to competing products;

FIG. 11 illustrates various moments in time, from a delivery intake to an outbound shipment within a warehouse environment, wherein a computing device of a warehouse management system may be prompted by a warehouse associate within the warehouse to complete decision-making tasks in order to provide streamlined processing of marketplace items and cartons within a warehouse setting, according to the principles of the present disclosure;

FIG. 12 is a flow diagram that illustrates interactions between a warehouse management system and a warehouse associate regarding selection of inventory from storage within the warehouse environment, according to the principles of the present disclosure;

FIG. 13 is a flow diagram that illustrates a process of determining what portions of the inventory to send to a marketplace, according to the principles of the present disclosure;

FIG. 14 is a flow diagram that illustrates a process of receiving inventory to the warehouse environment and subsequently processing the intake of inventory, according to the principles of the present disclosure;

FIG. 15 is a flow diagram that illustrates a process of generating shipment pre- creation statements, according to the principles of the present disclosure;

FIGS. 16A and 16B are flow diagrams that collectively illustrates a process of preparing items within the inventory for shipment outside of the warehouse environment, according to the principles of the present disclosure;

FIG. 17 is a flow diagram that illustrates a process of splitting quantities with regards to work orders, according to the principles of the present disclosure;

FIGS. 18A and 18B are flow diagrams that collectively illustrate a process of determining which type of carton label to print for respective boxes, according to the principles of the present disclosure; and

FIG. 19 is a flow diagram that illustrates a process of generating missing marketplace shipments, according to the principles of the present disclosure.

### DETAILED DESCRIPTION

Exemplary embodiments of the disclosure will be best understood by reference to the drawings, wherein like parts are designated by like numerals throughout. It will be readily understood that the components of the disclosure, as generally described and illustrated in the FIGS. herein, could be arranged and designed in a wide variety of different configurations. Thus, the following more detailed description of the embodiments of the apparatus, system, and method, as represented in the FIGS., is not intended to limit the scope of the disclosure, as claimed, but is merely representative of exemplary embodiments of the disclosure.

The phrases “connected to,” “coupled to” and “in communication with” refer to any form of interaction between two or more entities, including mechanical, electrical, magnetic, electromagnetic, fluid, and thermal interaction. Two components may be functionally coupled to each other even though they are not in direct contact with each other. The term “abutting” refers to items that are in direct physical contact with each other, although the items may not necessarily be attached together.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

In the present specification and in the appended claims the term “module” is meant as any computer executable program code, hardware, firmware, or a combination thereof that performs an action as instructed by a processor. In an embodiment, the modules may be completely defined by computer executable program code stored or maintained on a physical memory device within or among one or more computing devices such as a smartphone, a desktop computing device, and a laptop computing device, among others. In an embodiment, the module may be an application specific integrated circuit (ASIC) that is accessible by a processor to perform the actions and processes associated with that module.

As described, one of the problems commonly associated with common commerce systems and digital marketplaces is a management of the processing steps between a moment in time when a vendor prepares items, cartons, and/or other products for submission into a digital marketplace (e.g., intake) and another moment in time when said item, carton, product, etc. is shipped for fulfillment to an end customer (e.g., outtake).

Such processes traditionally require that a system gather information and materials manually from the marketplace's user interface and then provide them to a warehouse team in order to complete the preparatory steps on the product. Such preparatory steps also generally require staying compliant with the specific marketplace's requirements. Examples of steps required—to create a shipment virtually in a marketplace user interface, gather marketplace specific item labels, inform the marketplace of carton contents per carton, retrieve a carton-specific label for each carton, and inform the marketplace of a method of shipment.

Once the information is entered manually and the labels are retrieved, the vendor or brand has to give the labels to the brand's third party logistics provider or internal fulfillment partner in order to pick and process the units, cartons, and pallets for the marketplace. Once that is done, the shipment is then prepared for transportation and it is scheduled for pickup and delivery into a marketplace based on the availability for that specific shipment and vendor.

Due to the inherent, case-by-case basis of the processing and the manual nature (e.g., human involvement) of the retrieval and transmission of information from vendor to logistics provider, such antiquated types of processes remain batched processes, which are costly and error-prone methods of shipment creation and processing. Moreover, batch processing lacks efficient and scalable solutions that are then further degraded by potential and unpredictable human errors and/or delays.

Accordingly, systems and methods, such as those described herein, are configured to provide technology-driven and directed solutions that are both scalable and agnostic to specific digital marketplace procedures, may be desirable. The systems and methods, such as those described herein, are repeatable solutions for digital marketplaces that help overcome any combination of previous difficulties with speed, quality, safety, capacity, and/or cost in comparison to previous and antiquated methods. By being configured to optimize decision-making tasks throughout the lifecycle of a marketplace item and/or carton within a warehouse, systems and methods, such as those described herein, may reduce wait time for processing said item and/or carton in and out of a warehouse.

In some embodiments, the systems and methods described herein may be configured to determine logistical tasks related to order preparation and fulfillment from a vendor or brand to a marketplace warehouse. By incorporating the systems and methods described herein at various moments in time, the potential for human errors and/or unintentional delays in the workflow are further minimized, as the system provides technology-driven guidance and instructions to a user, indicating next steps throughout the overall process. By incorporating such a system into a warehouse and/or logistics environment, such processing steps are optimized, as the system maintains a global view of the overall process, start to finish. Such decision-making configurations by the systems and methods described herein may, in some embodiments, be considered as automating fulfilment orders between the vendor and marketplace.

Moreover, the computing devices that are configured to determine such tasks integrate the seller and a specific digital marketplace via the marketplace's Application Programming Interface (API). The systems described herein integrate a given vendor's marketplace connection via that marketplace's API. Item specific data, metadata, and/or other relevant information that is generated from the marketplace (e.g., a product SKU, carton information, carton label data etc.) is then stored in the system.

Furthermore, a web-based user interface described herein allows associates to interact with the stored data, metadata, and/or other relevant information. The system provides instructions indicating what is required to successfully complete the transaction. The user interface guides the associates through the warehouse processes and gathers data to pass to the marketplace. Inventory movements within the warehouse may be automated by the systems and methods described herein in order to reduce the amount of decision making by warehouse associates and to direct certain decision making to inventory managers with more expertise for overall improved efficiency and awareness.

In some embodiments, work orders may be generated that then provide the system with instructions indicating what should happen with a given item once it arrives at the warehouse. The system directs where the product should be sent and in what quantities. The system combines instructions from the work orders with product catalog data, such as marketplace prep instructions, to provide step-by-step instructions to the warehouse on how to handle items throughout the processing for marketplace shipping.

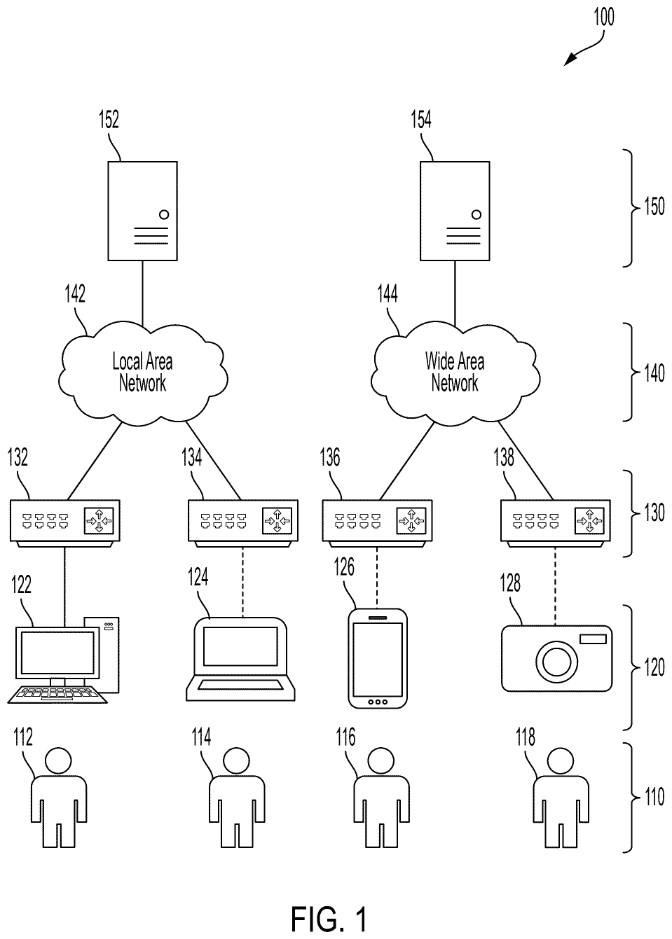

Referring to FIG. 1, a schematic block diagram illustrates a system 100 according to the principles of the present disclosure. The system 100 may be used for the benefit of one or more users 110, which may include a first user 112, a second user 114, a third user 116, and a fourth user 118 as shown in FIG. 1. Each of the users 110 may use one of a variety of computing devices 120, which may include any of a wide variety of devices that carry out computational steps, including but not limited to a desktop computer 122 used by the first user 112, a laptop computer 124 used by the second user 114, a smartphone 126 used by the third user 116, a camera 128 used by the fourth user 118, and the like. The system and method presented herein may be carried out on any type of computing device.

The computing devices 120 may optionally be connected to each other and/or other resources. Such connections may be wired or wireless, and may be implemented through the use of any known wired or wireless communication standard, including but not limited to Ethernet, 802.11a, 802.11b, 802.11g, and 802.11n, universal serial bus (USB), Bluetooth, cellular, near-field communications (NFC), Bluetooth Smart, ZigBee, and the like. In FIG. 1, by way of example, wired communications are shown with solid lines and wireless communications are shown with dashed lines.

Communications between the various elements of FIG. 1 may be routed and/or otherwise facilitated through the use of routers 130. The routers 130 may be of any type known in the art, and may be designed for wired and/or wireless communications through any known communications standard including but not limited to those listed herein. The routers 130 may include, for example, a first router 132 that facilitates communications to and/or from the desktop computer 122, a second router 134 that facilitates communications to and/or from the laptop computer 124, a third router 136 that facilitates communications to and/or from the smartphone 126, and a fourth router 138 that facilitates communications to and/or from the camera 128.

The routers 130 may facilitate communications between the computing devices 120 and one or more networks 140, which may include any type of networks including but not limited to local area networks such as a local area network 142, and wide area networks such as a wide area network 144. In one example, the local area network 142 may be a network that services an entity such as a business, non-profit entity, government organization, or the like. The wide area network 144 may provide communications for multiple entities and/or individuals, and in some embodiments, may be the Internet. The local area network 142 may communicate with the wide area network 144. If desired, one or more routers or other devices may be used to facilitate such communication.

The networks 140 may store information on servers 150 or other information storage devices. As shown, a first server 152 may be connected to the local area network 142, and may thus communicate with devices connected to the local area network 142 such as the desktop computer 122 and the laptop computer 124. A second server 154 may be connected to the wide area network 144, and may thus communicate with devices connected to the wide area network 144, such as the smartphone 126 and the camera 128. If desired, the second server 154 may be a web server that provides web pages, web-connected services, executable code designed to operate over the Internet, and/or other functionality that facilitates the provision of information and/or services over the wide area network 144.

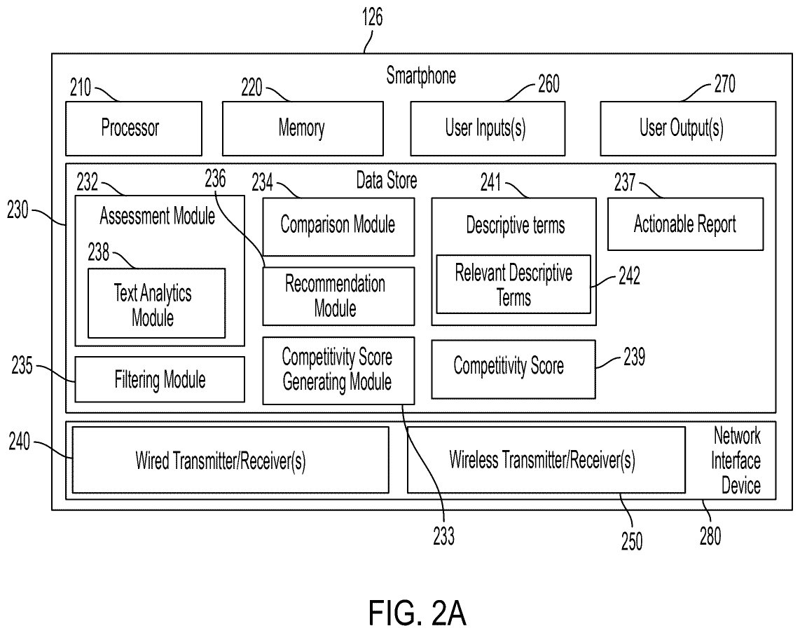

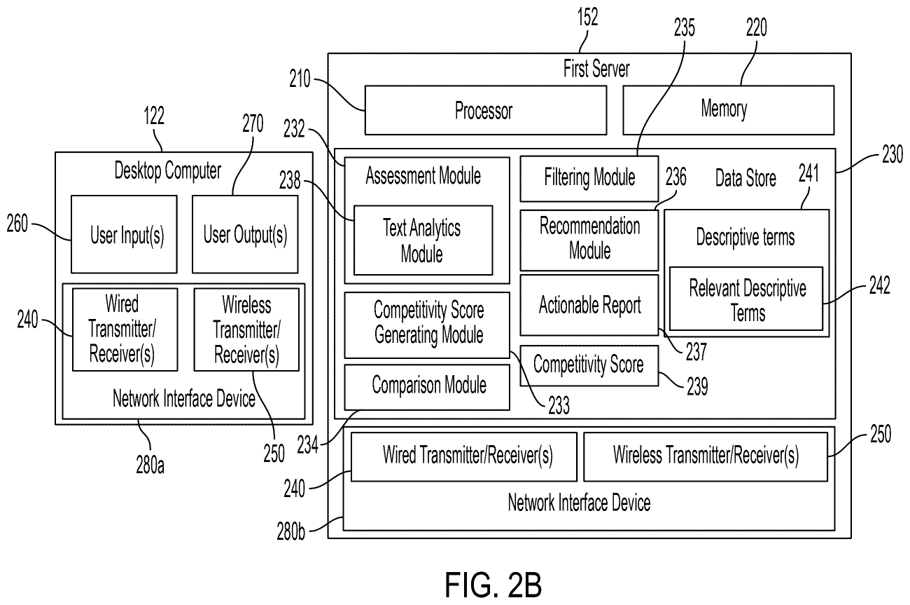

Referring to FIG. 2A, a schematic block diagram illustrates an exemplary computing device of the computing devices 120 that may enable implementation of the systems and methods described herein in a standalone computing environment. The computing device may be, for example, the smartphone 126 of FIG. 1. The present disclosure, however, contemplates that the computing device 120 may include any of those computing devices 120 described in FIG. 1 or any other type of computing device.

As shown, the smartphone 126 may include a processor 210 that is designed to execute instructions on data. The processor 210 may be of any of a wide variety of types, including microprocessors with x86-based architecture or other architecture known in the art, application-specific integrated circuits (ASICs), field-programmable gate arrays (FPGAs), and the like. The processor 210 may optionally include multiple processing elements, or “cores.” The processor 210 may include a cache that provides temporary storage of data incident to the operation of the processor 210.

The smartphone 126 may further include memory 220, which may be volatile memory such as random-access memory (RAM). The memory 220 may include one or more memory modules. The memory 220 may include executable instructions, data referenced by such executable instructions, and/or any other data that may beneficially be made readily accessible to the processor 210.

The smartphone 126 may further include a data store 230, which may be non-volatile memory such as a hard drive, flash memory, and/or the like. The data store 230 may include one or more data storage elements. The data store 230 may store executable code such as an operating system and/or various programs to be run on the smartphone 126. The data store 230 may further store data to be used by such programs. For the system and method of the present disclosure, the data store 230 may store computer executable code associated with an assessment module 232, a text analytics module 238, a filtering module 235, a comparison module 234, a recommendation module 236, and a competitivity score generating module 233. The data store 230 may further include data associated with descriptive terms 241 related to a target product and/or a competing product, relevant descriptive terms 242 associated with either of the target product or a competing product, a competitivity score 239, and an actionable report 237. This data stored by the data store 230 may be maintained on the data store 230 for any length of time and some data may be created or overwritten at any time to facilitate the methods described herein.

The smartphone 126 may further include one or more wired transmitter/receivers 240, which may facilitate wired communications between the smartphone 126 and any other device, such as the other computing devices 120, the servers 150, and/or the routers 130 of FIG. 1. The wired transmitter/receivers 240 may communicate via any known wired protocol, including but not limited to any of the wired protocols described in FIG. 1. In some embodiments, the wired transmitter/receivers 240 may include Ethernet adapters, universal serial bus (USB) adapters, and/or the like.

The smartphone 126 may further include one or more wireless transmitter/receivers 250, which may facilitate wireless communications between the smartphone 126 and any other device, such as the other computing devices 120, the servers 150, and/or the routers 130 of FIG. 1. The wireless transmitter/receivers 250 may communicate via any known wireless protocol, including but not limited to any of the wireless protocols described in FIG. 1. In some embodiments, the wireless transmitter/receivers 250 may include Wi-Fi adapters, Bluetooth adapters, cellular adapters, and/or the like. Either of the wired transmitter/receiver(s) 240 or wireless transmitter/receiver(s) 250 may be associated with a network interface device (NID) 280. The network interface device 280 may provide connectivity to, via the Internet, any network, e.g., a wide area network (WAN), a local area network (LAN), wireless local area network (WLAN), a wireless personal area network (WPAN), a wireless wide area network (WWAN), or other networks.

The smartphone 126 may further include one or more user inputs 260 that receive input from a user such as the any of the users 110 of FIG. 1. The users 110 described herein, may be referred to as a seller of a target product. The user inputs 260 may be integrated into the smartphone 126, or may be separate from the smartphone 126 and connected to it by a wired or wireless connection, which may operate via the wired transmitter/receivers 240 and/or the wireless transmitter/receivers 250. The user inputs 260 may include elements such as a touch screen, buttons, keyboard, mouse, trackball, track pad, stylus, digitizer, digital camera, microphone, and/or other user input devices known in the art.

The smartphone 126 may further include one or more user outputs 270 that provide output to a user such as any of the users 110 of FIG. 1. The user outputs 270 may be integrated into the smartphone 126, or may be separate from the smartphone 126 and connected to it by a wired or wireless connection, which may operate via the wired transmitter/receivers 240 and/or the wireless transmitter/receivers 250. The user outputs 270 may include elements such as a display screen, speaker, vibration device, LED or other lights, and/or other output devices known in the art. In some embodiments, one or more of the user inputs 260 may be combined with one or more of the user outputs 270, as may be the case with a touch screen. In an embodiment, the user outputs 270 may present to a user a graphical user interface by which the user may interact with the smartphone 126 in order to affect the methods and processes described herein.

The smartphone 126 may include various other components not shown or described herein. Those of skill in the art will recognize, with the aid of the present disclosure, that any such components may be used to carry out the present disclosure, in addition to or in the alternative to the components shown and described in connection with FIG. 2A.

The smartphone 126 may be capable of carrying out the present disclosure in a standalone computing environment, i.e., without relying on communication with other devices such as the other computing devices 120 or the servers 150. The present specification further contemplates that any of the assessment module 232, competitivity score generating module 233, comparison module 234, filtering module 235, recommendation module 236, and text analytics module 238 may be distributed amongst a number of computing devices (e.g., computing devices 120 of FIG. 1) and/or amongst any server (e.g., 150 of FIG. 1). In other embodiments, the present disclosure may be utilized in different computing environments. One example of a client/server environment will be shown and described in connection with FIG. 2B.

Referring to FIG. 2B, a schematic block diagram illustrates a computing device in the form of the desktop computer 122 of FIG. 1, and a server in the form of the first server 152 of FIG. 1, which may cooperate to enable practice of the disclosure with client/server architecture. As shown, the desktop computer 122 may be a “dumb terminal,” made to function in conjunction with the first server 152.

Thus, the desktop computer 122 may have only the hardware needed to interface with a user (such as the first user 112 of FIG. 1) and communicate with the first server 152. Thus, the desktop computer 122 may include one or more user inputs 260, one or more user outputs 270, one or more wired transmitter/receivers 240, and/or one or more wireless transmitter/receivers 250. Again, either of the wired transmitter/receiver(s) 240 or wireless transmitter/receiver(s) 250 may be associated with a NID 280a. The NID 280a may provide connectivity to, via the Internet, any network, e.g., a wide area network (WAN), a local area network (LAN), wireless local area network (WLAN), a wireless personal area network (WPAN), a wireless wide area network (WWAN), or other networks in which the first server 152 forms a part of. These components may be as described in connection with FIG. 2A.

Computing functions (apart from those incidents to receiving input from the user and delivering output to the user) may be carried out wholly or partially at the first server 152. Thus, the processor 210, memory 220, data store 230, wired transmitter/receivers 240, and wireless transmitter/receivers 250 may be housed in the first server 152. These components may also be as described in connection with FIG. 1A.

In operation, the desktop computer 122 may receive input from the user via the user inputs 260. The user input may be delivered to the first server 152 via the wired transmitter/receivers 240 and/or wireless transmitter/receivers 250. This user input may be further conveyed by any intervening devices, such as the first router 132 and any other devices in the local area network 142 that are needed to convey the user input from the first router 132 to the first server 152.

The first server 152 may conduct any processing steps needed in response to receipt of the user input. Then, the first server 152 may transmit user output to the user via the wired transmitter/receivers 240, and/or wireless transmitter/receivers 250. This user output may be further conveyed by any intervening devices, such as the first router 132 and any other devices in the local area network 142 (or, alternatively, a wide area network 144) that are needed to convey the user output from the first server 152 to the first router 132. The user output may then be provided to the user via the user outputs 270. In an embodiment, the user outputs 270 may present to a user a graphical user interface that, according to the methods described herein, display a listing of relevant descriptive terms 242 of the target product and competitive product as well as display an actionable report that describes a projected performance of the target product in a computer-networked marketplace relative to the at least one organic competing product also presented on the computer-networked marketplace.

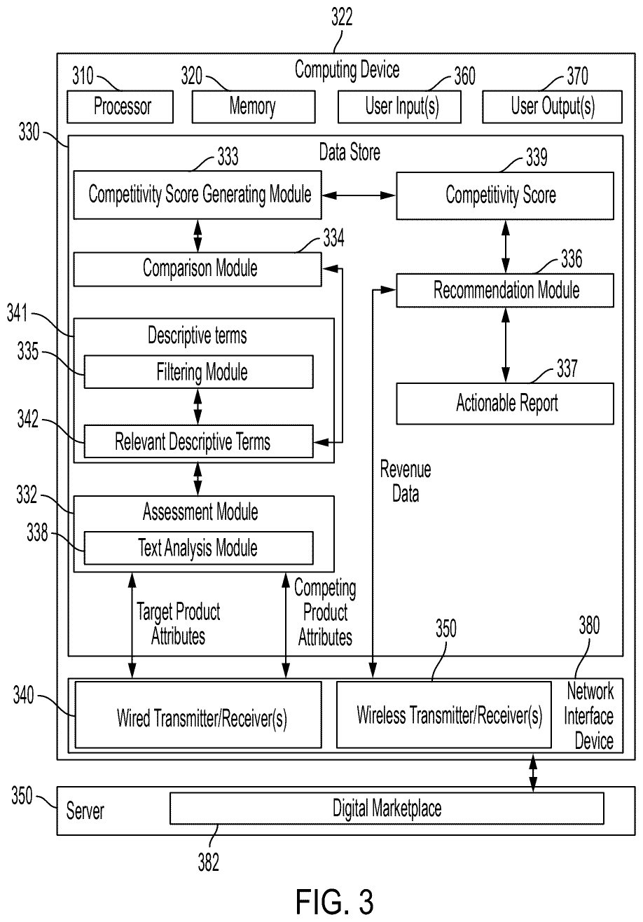

Referring to FIG. 3, a schematic block diagram illustrating a computing device 322 (similar to any one of the computing devices shown in FIG. 1) and a server 350 (similar to any of the servers shown in FIG. 1) operating a digital marketplace, which may cooperate to enable practice of the disclosure with client/server architecture, according to one embodiment of the disclosure. As shown, the computing device 322 may be operatively coupled to the server 350 via the NID 380 as described herein. This operative coupling allows the computing device 322 to access, when appropriate, a digital marketplace 382 on which a target product and competitive product are sold. The digital marketplace 382 may be any network accessible website that lists a number of products that, when accessed by a user, allows a user to review products, rate products, purchase products among other tasks associated with digital commerce. The digital marketplace 382 may be managed by companies that include eBay®, Amazon®, Wayfair®, Costco®, Walmart®, and Target®, among others. Upon purchase of a product, a consumer may have the purchased product sent to the consumer's home or business for consumption. In an embodiment, the digital marketplace 382 may be any of a plurality of websites that the server 350 provides storage and processing resources for.

As described herein, the computing device 322 may include a processor 310, a memory 320, user inputs 360, user outputs 370 and a data store 330 that operate similar to those similar elements described in connection with FIGS. 2A and 2B. The data store 330 may include those modules described herein including an assessment module 332, a competitivity score generating module 333, a comparison module 334, a filtering module 335, a recommendation module 336, and a text analytics module 338.

During operation, the assessment module 332 may assess certain attributes of a target product. The target product as described herein is a specific target product a user (e.g., seller) of the computing device 322 is seeking to discover the competitivity of the product within a certain market. For example, the target product may be a product the user is selling or would like to sell on the digital marketplace 382 hosted by the server 350. In order to know the target products competitiveness, the assessment module 332 may access certain data about the target product present on the server 350. The data may be accessed by the assessment module 332 by sending data requests via the NID 380 either via a wired (e.g., via the wired transmitter/receiver(s) 340)) or a wireless (e.g., via the wireless transmitter/receiver(s) 350) connection.

The data request may be a request for attributes regarding the target product. Although any number of attributes about the target product may be requested, the assessment module 332 may request specific attributes that will be used to develop an actionable report 337 regarding the competitivity of the target in the digital marketplace 382. A first attribute may be descriptive of the ratings provided by at least one purchaser of the target product on the digital marketplace 382. Often, digital marketplaces 382 provide graphical user interfaces (GUIs) to consumers that allows those consumers to rate the products they purchase on the digital marketplace 382. In a specific embodiment, a 5-star starring system may be used by a consumer/purchaser of the target product to rate the target product. A one-star rating would indicate a poor assessment by the consumer/purchaser of the target product while a 5-star rating would indicate a very good assessment of the target product by the consumer/purchaser. The assessment module 332 may, therefor, take each star-rating or an average of those star-ratings as input for use in creating the actionable report 337.

A second attribute may include the reviews associated with the target product. Again, digital marketplaces 382 often provide a GUI that allow the consumer of the target product to enter text descriptive of the consumers' experiences with the target product. This text may include specific positive keywords or negative keywords that describe the consumers' experience with the target product. With this data, the assessment module 332 may cause a text analytics module 338 to, in an embodiment, parse each review for these keywords that describe the target product. Still further, the text analytics module 338 may also extract keywords descriptive of certain features of the target product. As an example, the wording “ergonomic handle” may be extracted by the text analytics module 338 describing not only that the target product includes a handle, but that that handle is an “ergonomic” handle giving a perception that the consumer giving that review likes the fit or feel of the target product.

A third attribute may be similar to the second attribute in that the assessment module 332 determines the number of the reviews associated with the target product presented on the digital marketplace 382. The number of reviews may indicate a level of involvement with the target product either for the disparaging of the target product or the approval of the target product. Along with the textual substance of these reviews, the number of reviews associated with the target product may be used to help create the actionable report based on the involvement within the digital marketplace 382 with the target product.

A fourth attribute may include the listed price of the target product. Although the amount charged to purchase a product may not be indicative of the value of the target product, the charged amount relative to other similar competing products may be indicative of its worth or current price point (whether incorrect or correct).

A fifth attribute may also include a ranking of the target product relative to at least one organic competing product. This ranking may be a result of an average or accumulative rating of the target product relative to the organic competing product. Often, the digital marketplaces 382 allow purchasers to list organic competing products and the target product by an average rating. By doing so the assessment module 332 may understand the ranking of the target product relative to the at least one organic competing product and use this information to develop the actionable report 337.

The assessment module 332 may also determine similar attributes of an at least one organic competing product similar to those attributes discovered by the assessment module 332 for the target product. In the context of the present specification the term “organic competing product” is meant to be understood as any product that, based on consumer reviews, is ranked on the digital marketplace 382. An “organic” competing product is therefore a naturally ranked product based on those reviews provided by past consumers as opposed to those products that may be given “top shelf” preference after payment to achieve such status. This organic ranking nature of products on the digital marketplace 382 is often done to provide potential consumers with evidence that others appreciate that product. A “competing” product is any product that is similar to the target product but sold by another seller apart from the seller of the target product. The “similarity” of the target product relative to the at least one organic competing product is dependent on the data obtained by the text analytics module 338 and specifically the analysis of descriptive terms 341 associated with each of these types of products. In a specific embodiment, the text analytics module 338 may also obtain descriptive data associated with each target product and organic competing product per their listing. Again, digital marketplaces 382 allow descriptions of products to be posted alongside each product that describes is functionalities, its physical characteristics, and its alleged advantages as superior products. All of this is presented to a potential consumer on a GUI as textual information used to entice the consumer to purchase the products. The text analytics module 338 may analyze this text and, using a parsing process, extract keywords used to compare the text associated with the target product to the text associated with the organic competing product.

When the computing device 322, via the assessment module 332, has obtained the attributes associated with the target product and the at least one organic competing product, the descriptive terms 341 describing these attributes may be listed for consumption by, in an embodiment, a filtering module 335. The filtering module 335 may be used to filter the descriptive terms 341 to only those relevant descriptive terms 342 that have resulted in the purchase of the target product in the digital marketplace 382. For example, some descriptive terms 341 may, rightly or wrongly, include a color or color scheme of the target product or organic competing product. Although some consumers may appreciate a specific color of a product, these may not be deciding factors used to entice a consumer to purchase the target product or organic competing product. This may be especially true where, as indicated by purchase histories associated with the target product or organic competing product indicate that any particular color of product was not overwhelming purchased over another color. In this specific example, although the color of the product is a descriptive term 341 the text analytics module 338 had parsed out from the products, it may not necessarily be a relevant descriptive term 341 and such information may be filtered out by the filtering module 335 to obtain only those relevant descriptive terms 342 associated with any of the target product or organic competing product.

In a more general example, the filtering module 335 may narrow down the descriptive terms 341 of interest by analyzing metrics collected on sufficiently “mature” keywords (e.g., sales >2) as budding keywords that may lack sufficient data to influence predictions in purchasing the target product or organic competing product. The click-rate and conversion rate (clicks that result in a purchase) associated with any given product may be taken into consideration based on the keywords used to search for the products. In these examples, a lack of data regarding a specific descriptive term 341 may also filter out that specific descriptive term 341 in order to obtain the relevant descriptive terms 342 as described herein. It is also appreciated that the descriptive terms 341 may be filtered by the filtering module 335 based on any other reason to obtain relevant descriptive terms 342 and the present specification contemplates these other reasons.

With the relevant descriptive terms 342 being determined, these relevant descriptive terms 342 may be sent to a comparison module 334 to compare those relevant descriptive terms 342 of the target product to those relevant descriptive terms 342 associated with the at least one organic competing product. Although the present specification describes this comparison process as being conducted between a single organic competing product (e.g., “at least one”) to the target product, any number of organic competing products may be compared to the target product. In a specific example, the top 10 ranked organic competing products may be compared to the target product by the comparison module 334.

During execution of the comparison module 334 by the processor 310, the descriptive terms 341 may be compared to generate, with a competitivity score generating module 333 executed by the processor 310, a competitivity score 339. In an embodiment, the competitivity score may use any process or algorithm used to define how the target product can or cannot compete with any of the discovered organic competing products.

During operation, a recommendation module 336 may receive this competitivity score 339 along with other data from the digital marketplace 382 hosted by the server 350. Among this other data may include revenue data associated with the organic competing products and the target product (if available). For example, where a click-rate of any given product (e.g., target product or organic competing product) results in a purchase, this conversion rate data along with the pricing data of the products may be passed to the recommendation module 336. The recommendation module 336 may then provide a recommendation descriptive of the ability (or inability) of the target product to compete with the at least one organic competing product. In an example, a threshold competitivity score may be set such that the report provided by the recommendation module 336 indicates to the seller of the target product whether to proceed to sell that product on the digital marketplace 382. Alternatively, where the competitivity score has not met the threshold the competitivity score generating module 333 may not forward the competitivity score onto a recommendation module 336 to generate the actionable report 337. Alternatively, or additionally, where the competitivity score has not met the threshold the competitivity score generating module 333 may pass a threshold failure signal onto to the recommendation module 336 indicative of a non-competitive status of the target product. When the threshold competitivity score is not reached, the recommendation module 336 may provide an indication to the seller that it is not recommended that the seller initiate or continue to sell the target product on the digital marketplace 382.

Where the threshold competitivity score is reached, the recommendation module 336 may provide additional economic data descriptive of price points and ACoS statistics to use in order to increase revenue. Again, a seller of the target product may not know what appropriate target advertising cost of sale (ACoS) to meet or exceed and what price point to sell the target product at in order to see long term gains in lieu of short-term profits. The recommendation module 336 provides this information based on the competitivity score 339 generated by the competitivity score generating module 333 and revenue data received from the digital marketplace 382. In a specific example, the revenue potential of the target product may be determined by the recommendation module 336 calculating an ad spend margin, an ad spend potential, and a revenue potential. The ad spend margin may be calculated by multiplying a target ACoS by the price of the target product. A target ACoS may be determined and set by the seller based on available capitol or may be set by the seller based on the fraction of the revenue received thus far from the sale of the target product on the digital marketplace 382 and costs of manufacturing. Ad spend potential may then be calculated by multiplying monthly opportunity units (OU) by the spend margin. The monthly OUs may be calculated as a result of the conversion rate of clicks to the target product that is the results of sales of the target product after a purchaser has viewed the product. The revenue potential may then be calculated by multiplying the OU with the price of the target product. This revenue potential of each of the target products and organic competing products may be ranked to determine the placement of the target product within the digital marketplace 382.

In an embodiment, the recommendation (e.g., the actionable report 337) presented by the recommendation module 336 may be refined by inputting an estimated bid amount from the digital marketplace 382 required to “win” advertising slots for the target product. The digital marketplace 382, along with selling products, may also engage in presenting advertisements to a potential purchaser of one or more products. These advertisements may be presented in a banner or other sub-section of the GUI presented to the purchaser or as a pop-up window advertisement. These forms of advertisements present, in real-time, alternative products for which the potential purchaser is seeking to purchase. These advertisements may present the target product and persuade the purchaser to purchase the target product rather than a competitors' products. Thus, investments may be required to increase the purchasing instances of the target product. The present systems and methods may also present to the seller of the target product, on the actionable report 337, how much additional investment may be needed to win advertising slots based on the keywords associated with the target product and entered into a search by a potential user. For example, the investment needed may be calculated by multiplying the projected bid amount by the product of the click rate of the target product and the impressions (e.g., uses) for specific keywords associated with the target product and the organic competing product used to search for those products. A return on investment (ROI) may then be calculated by subtracting the investment needed from an investment payoff term and multiplying that by the ad spend potential. Products with no (or low) destiny potential receive suggestion outputs as to why they are not competitive or have bad conversion rates by the recommendation module 336 and its actionable report 337, so that these attributes of the target product can be improved for future destiny potential or the money spent to sell the target product can be reallocated for other uses.

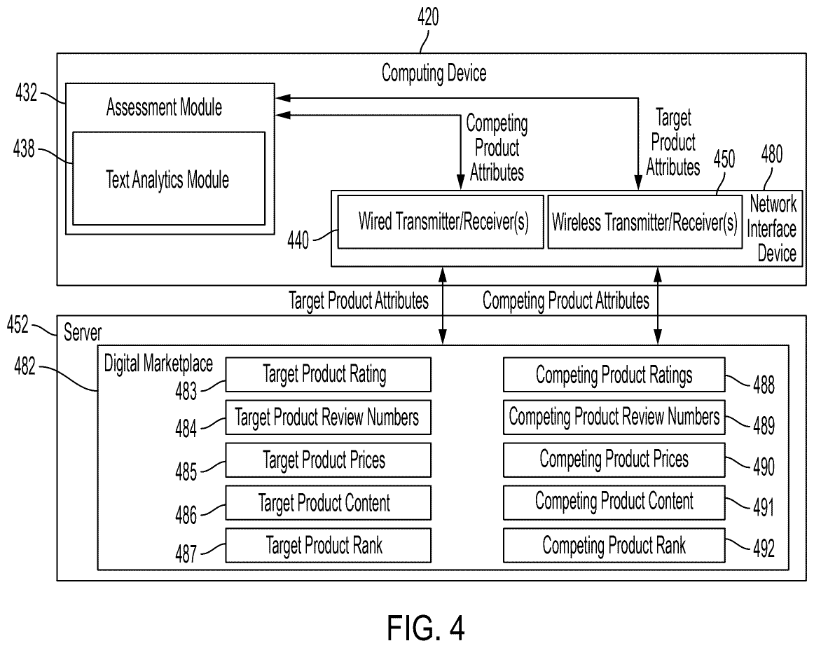

FIG. 4 is a schematic block diagram illustrating a computing device 420 and a server 452 in hosting a digital marketplace 482 that includes attributes of a target product and a competing product, which may cooperate to enable practice of the disclosure with client/server architecture. As described herein, the assessment module 432 may assess certain attributes of a target product. The target product as described herein is a specific target a user (e.g., seller) of the computing device 420 is seeking to discover the competitivity of the product within a certain market. For example, the target product may be a product the user is selling or would like to sell on the digital marketplace 482 hosted by the server 452. In order to know the target products competitiveness, the assessment module 432 may access certain data about the target product present on the server 452. The data may be accessed by the assessment module 432 by sending data requests via the NID 480 either via a wired (e.g., via the wired transmitter/receiver(s) 440)) or a wireless (e.g., via the wireless transmitter/receiver(s) 450) connection.

The data request may be a request for attributes regarding the target product. Although any number of attributes about the target product may be requested, the assessment module 432 may request specific attributes that will be used to develop an actionable report regarding the competitivity of the target in the digital marketplace 482. A first attribute may be descriptive of the ratings 483 provided by at least one purchaser of the target product on the digital marketplace 482. Often, digital marketplaces 482 provide graphical user interfaces (GUIs) to consumers that allows those consumers to rate the products they purchase on the digital marketplace 482. In a specific embodiment, a 5-star starring system may be used by a consumer/purchaser of the target product to rate the target product. A one-star rating would indicate a poor assessment by the consumer/purchaser of the target product while a 5-star rating would indicate a very good assessment of the target product by the consumer/purchaser. The assessment module 432 may, therefore, take each star-rating or an average of those star-ratings as input for use in creating the actionable report.

A second attribute may include the content 486 of the reviews and description associated with the target product. Again, digital marketplaces 482 often provide a GUI that allow the consumer of the target product to enter text descriptive of the consumers' experiences with the target product. This text may include specific positive keywords or negative keywords that describe the consumers' experience with the target product. With this data, the assessment module 432 may cause a text analytics module 438 to, in an embodiment, parse each review for these keywords that describe the target product. Still further, the text analytics module 438 may also extract keywords descriptive of certain features of the target product. As an example, the wording “ergonomic handle” may be extracted by the text analytics module 438 describing not only that the target product includes a handle, but that that handle is an “ergonomic” handle giving a perception that the consumer giving that review likes the fit of the target product.

A third attribute may be the number of the reviews 484 associated with the target product presented on the digital marketplace 482. The number of reviews 482 may indicate a level of involvement with the target product either for the disparaging of the target product or the approval of the target product. Along with the textual substance of these reviews, the number of reviews associated with the target product may be used to help create the actionable report based on the involvement within the digital marketplace 482 with the target product.

A fourth attribute may include the listed price 485 of the target product. Although the amount charged to purchase a product may not be indicative of the value of the target product, the changed amount relative to other similar competing products may be indicative of its worth or current price point (whether incorrect or correct).

A fifth attribute may also include a ranking 487 of the target product relative to at least one organic competing product. This ranking may be a result of an average or accumulative rating of the target product relative to the organic competing product. Often, the digital marketplaces 382 allow purchasers to list organic competing products and the target product by an average rating. By doing so the assessment module 432 may understand the ranking of the target product relative to the at least one organic competing product and use this information to develop the actionable report.

Each of these target product attributes may be requested by the computing device 420 and its assessment module 432 and delivered by the server 452 upon request. Even further, similar attributes related to at least one organic competing product may also be requested by and sent to the computing device 420. These organic product attributes may include competing product ratings 488, competing product review numbers 489, competing product prices 490, competing product content 491, and competing product rank 492. Each of these competing product attributes may be similar to those attributes associated and described herein in connection with the target product.

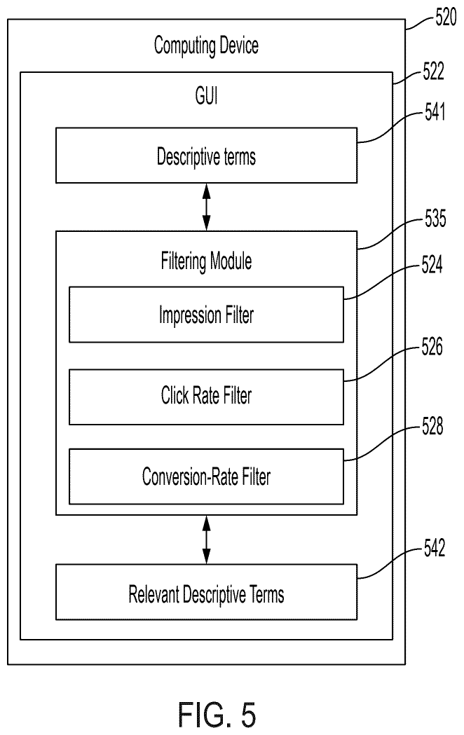

FIG. 5 is a schematic block diagram illustrating a computing device 520 that includes a graphic user interface (GUI) 522 used to enable practice of the disclosure within a client/server architecture. The graphic user interface 522 may be used by a seller of a target product to evaluate the competitivity of the target product as described herein. As described herein, the computing device 520 includes a filtering module 535. The filtering module 535 may be used to filter the descriptive terms 541 to only those relevant descriptive terms 542 that have resulted in the purchase of the target product in the digital marketplace.

The filtering module 535 may include a number of types of filters to filter the descriptive terms 541 into the relevant descriptive terms 542. These filters may include an impression filter 524, a click-rate filter 526, and a conversion-rate filter 528 each of which may result in the removal of descriptive terms 541 that do not result in purchases of the target product or any organic comparison product. As described herein, the impression filter 524 may be provided with a number of times an ad associated with the target product or competing product (whether it is a banner, button, or text link) has been (or will be) exposed to a potential purchaser and has resulted in a purchase of that product. The impression filter 524 may therefore, filter out those instances where a potential purchaser did not see or was not shown an ad but did result in a purchase. Click-rate filter 526 may filter out those descriptive terms that, despite the wording of the ad, did not result in a selection of the ad or a purchase of the product. The conversion-rate filter 528 may filter out those descriptive terms that, despite the wording of the ad and a selection by the potential purchaser of the ad, did not result in a purchase of the product.

By filtering the descriptive terms via the filtering module 535 and its associated filters 524, 526, 528, the GUI 522 may be able to display to a seller of the target product those relevant descriptive terms 542 that apply in the analysis of how competitive the target product is. Although FIG. 5 shows the use of specific filters 524, 526, 528 to filter the descriptive terms 541, the present specification contemplates that the descriptive terms 541 may be filtered using any criteria.

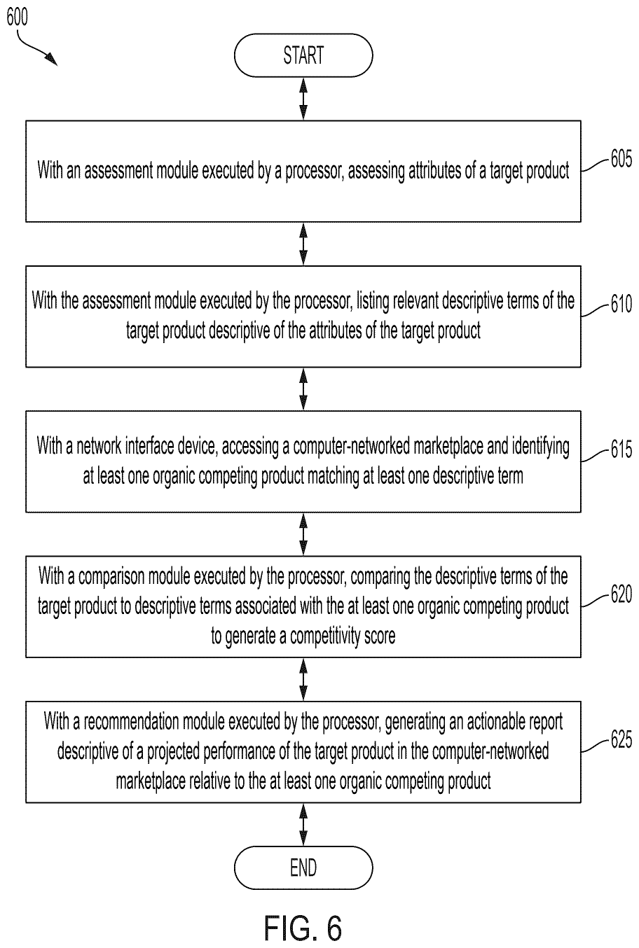

FIG. 6 is a flowchart diagram illustrating a method 600 of evaluating a product, according to one embodiment of the disclosure. The method 600 may begin at block 605 with assessing attributes of a target product using an assessment module executed by a processor. As described herein, the assessment of the target product (or any other competing product) may indicate certain attributes of the target product. Although any number of attributes about the target product may be requested, the assessment module may request specific attributes that will be used to develop an actionable report regarding the competitivity of the target in the digital marketplace.

At block 610, the method 600 may further include listing relevant descriptive terms of the target product descriptive of the attributes of the target product. This listing of the relevant descriptive terms may also be conducted by the assessment module being executed by the processor of the computing device. This list of relevant descriptive terms, in an embodiment, may have been generated based on the filtering of all descriptive terms generated for the target product as described herein. There may be some irrelevant information that may be filtered out of the descriptive terms generated from the attributes of the target product that would not need to show up in the actionable report.

The method 600 may continue at block 615 with accessing a computer-networked marketplace, via a NID, and identifying at least one organic competing product matching at least one descriptive term. This identification may implement the assessment module to compare the descriptive terms associated with the target product to any generated descriptive terms associated with any organic competing product. In an embodiment, this matching process of descriptive terms related to the target product to descriptive terms related to the organic competing product may be conducted before or after the filtering of descriptive terms by a filtering module as described herein. When conducted before, more organic competing products may be matched where, when conducted after the filtering, relatively less organic competing products may be matched due to the smaller list of relevant descriptive terms.

The method 600 may also include comparing the descriptive terms of the target product to descriptive terms associated with the at least one organic competing product to generate a competitivity score at block 620. This may be done via execution of a comparison module 620 executed by the processor. During execution of the comparison module by the processor, the descriptive terms may be compared to generate, with a competitivity score generating module executed by the processor, a competitivity score. In an embodiment, the competitivity score may use any process or algorithm used to define how the target product can or cannot compete with any of the discovered organic competing products.

At block 625, the method 600 may further include generating an actionable report descriptive of a projected performance of the target product in the computer-networked marketplace relative to the at least one organic competing product. The actionable report may be generated via the execution of a recommendation module by the processor. During operation, a recommendation module may receive this competitivity score along with other data from the digital marketplace hosted by the server. Among this other data may include revenue data associated with the organic competing products and the target product (if available). For example, where a click-rate of any given product (e.g., target product or organic competing product) results in a purchase, this conversion rate data along with the pricing data of the products may be passed to the recommendation module. The recommendation module may then provide a recommendation descriptive of the ability (or inability) of the target product to compete with the at least one organic competing product. In an example, a threshold competitivity score may be set such that the report provided by the recommendation module 336 indicates to the seller of the target product whether to proceed to sell that product on the digital marketplace. Alternatively, where the competitivity score has not met the threshold the competitivity score generating module may not forward the competitivity score onto a recommendation module to generate the actionable report. When the threshold competitivity score is not reached, the recommendation module simply provides an indication to the seller that it is not recommended that the seller initiate or continue to sell the target product on the digital marketplace.

Where the threshold competitivity score is reached, the recommendation module may provide additional economic data descriptive of price points and ACoS statistics to use in order to increase revenue. Again, a seller of the target product may not know what appropriate target ACoS to meet or exceed and what price point to sell the target product at in order to see long term gains in lieu of short-term profits. The recommendation module provides this information based on the competitivity score generated by the competitivity score generating module and revenue data received from the digital marketplace. In a specific example, the revenue potential of the target product may be determined by the recommendation module calculating an ad spend margin, an ad spend potential, and a revenue potential. The ad spend margin may be calculated by multiplying a target ACoS by the price of the target product. A target ACoS may be determined and set by the seller based on available capitol or may be set by the seller based on the fraction of the revenue received thus far from the sale of the target product on the digital marketplace and costs of manufacturing. Ad spend potential may then be calculated by multiplying monthly opportunity units (OU) by the spend margin. The monthly OUs may be calculated as a result of the conversion rate of clicks to the target product that is the results of sales of the target product after a purchaser has viewed the product. The revenue potential may then be calculated by multiplying the OU with the price of the target product. This revenue potential of each of the target products and organic competing products may be ranked to determine the placement of the target product within the digital marketplace.

At this point, the method 600 may end.

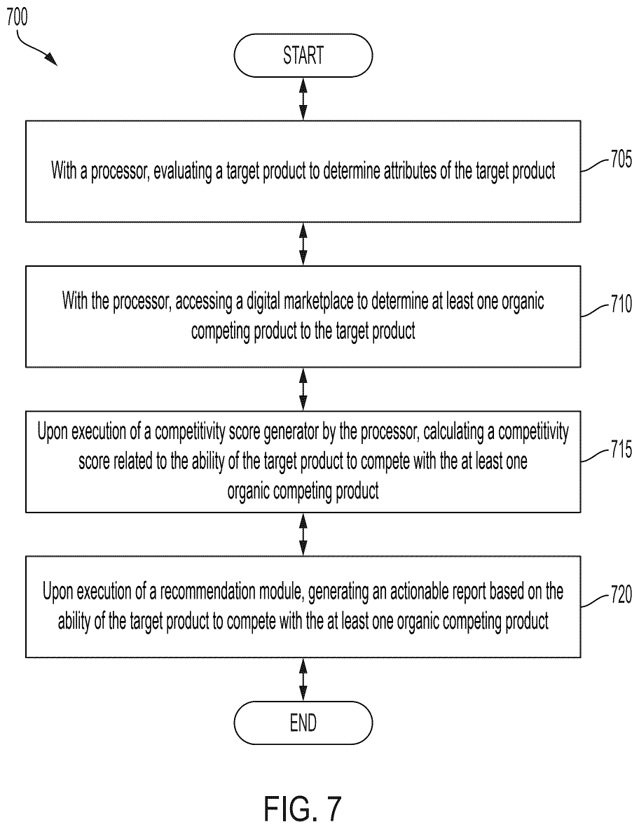

FIG. 7 is a flowchart diagram illustrating a method 700 of providing a competitive assessment of a target product on a marketplace, according to one embodiment of the disclosure. Here, the method 700 may begin with evaluating a target product to determine attributes of the target product at block 705. In an embodiment, the evaluation may be conducted via the execution of an assessment module. In an embodiment, the assessment may be conducted by requesting, at a GUI, descriptive terms regarding the target product. Additionally, or alternatively, the evaluation may be made by an assessment module accessing a digital marketplace to retrieve descriptive terms via a text analytics module as described herein. Additionally, or alternatively, certain input devices such as a digital camera may be used to image the target product and extrapolate certain features of the product such as size, color, texture, among others.

The method 700 may continue at block 710 with accessing the digital marketplace to determine at least one organic competing product to the target product upon execution of the processor. In this embodiment, the assessment module may access certain data about the target product such as the descriptive terms and cross-reference those descriptive terms to determine if at least one descriptive term matches any competing product listed on the digital marketplace.

At block 715, the method 700 may include calculating a competitivity score related to the ability of the target product to compete with the at least one organic competing product. This process may be conducted upon execution of a competitivity score generator by the processor of the computing device accessing the digital marketplace. In an embodiment, the competitivity score may use any process or algorithm used to define how the target product can or cannot compete with any of the discovered organic competing products.

The method 700 may further include generating an actionable report based on the ability of the target product to compete with the at least one organic competing product at block 720. During operation, a recommendation module, executed by the processor, may receive the competitivity score along with other data from the digital marketplace hosted by the server. Among this other data may include revenue data associated with the organic competing products and the target product (if available). For example, where a click-rate of any given product (e.g., target product or organic competing product) results in a purchase, this conversion rate data along with the pricing data of the products may be passed to the recommendation module. The recommendation module may then provide a recommendation descriptive of the ability (or inability) of the target product to compete with the at least one organic competing product. In an example, a threshold competitivity score may be set such that the report provided by the recommendation module indicates to the seller of the target product whether to proceed to sell that product on the digital marketplace. Alternatively, where the competitivity score has not met the threshold the competitivity score generating module may not forward the competitivity score onto a recommendation module to generate the actionable report. When the threshold competitivity score is not reached, the recommendation module simply provides an indication to the seller that it is not recommended that the seller initiate or continue to sell the target product on the digital marketplace. At this point, the method 700 may end.

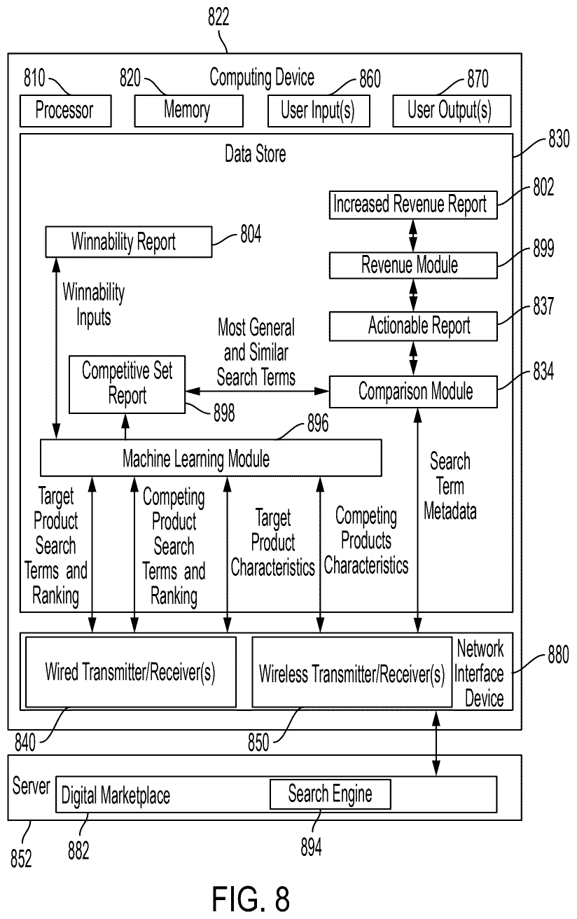

FIG. 8 is a schematic block diagram illustrating computing device 822 and a server 852 in operating a digital marketplace 882, which may cooperate to enable practice of the disclosure with client/server architecture. In addition to providing an actionable report (FIG. 3, 337) regarding the competitivity of the target in the digital marketplace 882 as described in connection with FIGS. 1-7, the present computing device 822 may further describe an actionable report 837 that describes sustainable and feasible growth over time on an ecommerce platform (e.g., the digital marketplace 882) on a product level as well as provide a winnability report 804 descriptive of a probability of winning each search term (e.g., having the target product associated with the search term) at any given point in time along with the estimated costs to win those search terms. The actionable report 837 and winnability report 804 may, in an embodiment, provide a user with an indication as to how to optimize advertising and search engine implementation to increase revenue.

As described herein, the computing device 822 may include a processor 810, a memory 820, user inputs 860, user outputs 870 and a data store 830 that operate similar to those similar elements described in connection with FIGS. 2A and 2B, for example. The data store 830 may include those modules described herein including a comparison module 834, and a revenue module 899.

The computing device 822 described may include any module, data store 830, or data maintained on the computer as those described in connection with FIG. 3 herein. In the embodiments described herein, an actionable report 837 may be provided using a comparison module 834 similar to the comparison module 334 described in connection with FIG. 3. Although these modules (e.g., comparison module 834) may be similar to those described in FIG. 3, the modules in FIG. 8 may perform additional and different processes as described herein in order to provide an actionable report 837 indicating optimized advertising and search engine implementation.

In an embodiment, the computing device 822 may initially determine any competitive products that, at any point in time, compete with the target product. The computing device 822 may do this by accessing a search engine 894 associated with a digital marketplace 882 via the processor 810 and NID 880 of the computing device 822. Upon accessing the search engine 894, the processor 810 may retrieve data descriptive of the frequency of appearance of one or more search terms associated with the target product. Additionally, the processor 810 may obtain data related to the ranking of those search terms. This data may be descriptive of the coincidence that the target product and any competitive product are associated with the same search terms. Still further, this data may be descriptive of how the search terms associated with the target product and each competitive product are similar in their rankings. For example, where the target product is an athletic shoe, some pertinent search terms may include running, hiking, basketball, tennis, sole, laces, and marathon among other potential terms associated with the target product athletic shoe. The data may also include which competing products also rank similarly with these terms. For example, a competing product that matches 9 out of 10 search terms with the target product is “higher ranked” as compared to a competing product that matches 4 out of 10 search terms.

In a specific embodiment, the processor 810 may access this data using, for example, a search query website such as Google® Trends®. These types of websites may be used by the processor 810 to access a number of search queries for specific terms associated with any of the target product and any number of competitive products. The search query websites may be accessed by the processor 810 to automatically access search query inquiries in order to obtain the data used herein by the computing device 822. Although specific search query websites are contemplated herein, the present specification also contemplates that other search query databases may be accessed by the processor 810 whether those databases are accessible by a user via a website or not.

The computing device 822 also includes a machine learning module 896. The machine learning module 896 may build a number of mathematical models that provide a competitive set report 898 describing a competitive set of products that compete with the target product. As with each machine learning module 896, the machine learning module 896 may be “taught” by using, as input, a plurality of sets of target product search terms and rankings as well as a plurality of sets of competing product search terms and rankings. Again, the plurality of sets of target product search terms and rankings as well as a plurality of sets of competing product search terms and rankings may be accessible by the processor 810 either via a specific search query website or database.

The machine learning module 896 in an embodiment may, upon execution by the processor 810, determine such correlations in an embodiment based on any machine learning or neural network methodology known in the art or developed in the future. In a specific embodiment, the machine learning module 896 may implement an unsupervised learning clustering technique. For example, the machine learning module in an embodiment may model the relationships between each plurality of sets of target product search terms and rankings as well as a plurality of sets of competing product search terms and rankings using a layered neural network topology. Such a neural network in an embodiment may include an input layer (e.g., plurality of sets of target product search terms and rankings as well as a plurality of sets of competing product search terms and rankings) including a known, recorded set of values for each of these parameters, settings, indicators, and usage data metrics, and an output layer including a projected optimal competitive set report 898, based on the known, recorded set of values in the input layer. The machine learning module 896 in an embodiment may propagate input through the layers of the neural network to project or predict optimal competitive set report 898 based on the known and recorded search term metrics, and compare these projected values to optimal search terms to be presented in the competitive set report 898. Using a back-propagation method, the machine learning module 896, in an embodiment, may then use the difference between the projected values and the known optimal values to adjust weight matrices of the neural network describing the ways in which changes in each of the search term data metrics are likely to affect the optimal search terms to be presented in the competitive set report 898.

With the output layer, the computing device 822 may provide learned competitive search terms that are determined to be the optimal search terms if any have been designated and based upon the similar and frequent search terms detected at the search engine 894 of the digital marketplace 882 during use of the computing device 822. These resulting learned optimal search terms may be suggested to a user or automatically implemented. Suggestion may come with an indicator and may be shown in a graph at a user interface for, in an embodiment, approval by the user before implementation of the other processes executed by the processor 810 of the computing device 822.

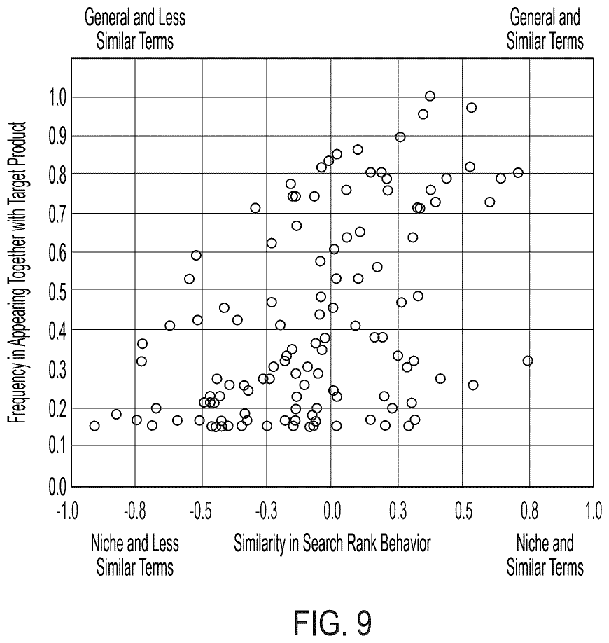

An example representation of the graph is shown in FIG. 9. This example graph may indicate positions of each search term of a competitive product relative to the target product based on the frequency. Each point (e.g. circle) on the graph represented in FIG. 9 is representative of a search term. Each representative search term is arranged on the graph in FIG. 9 at a point that defines that terms frequency in appearing together with a search term of the target product and at a position where the search term is similar or not relative to the search terms associated with the target product. In this example graph, the further to the right any given search term is, the more similar the search terms of a competitive product are similar to the search terms of the target product. Additionally, the further to the left any given search term is, the less similar the search terms of the competitive product are similar to the search terms of the target product. Further, the closer to the top of the graph any given search term is, the more general the search term is compared to the target product while the closer to the bottom of the graph any given search term is, the more niche the search term is compared to the target product. In an embodiment, it may be most desirable to have a target product that has associated search terms relative to the search terms of a competitive product that is more general and similar. This indicates that the target product is competing with relatively well-known competing products. The processes described herein, may help to provide a report to a user indicative of how to adjust advertisement revenue to focus on more general and similar search terms as the competitive products.

In an embodiment, the machine learning module 896 may perform a forward propagation and backward propagation, using different input node values repeatedly to finely tune any matrices either weighted or not. In such a way, the machine learning module 896, in an embodiment, may adaptively learn how changes in the plurality of sets of target product search terms and rankings as well as a plurality of sets of competing product search terms and rankings may affect the data reflected in the competitive set report 898. The weight matrices associated with the layers of the neural network model in such an embodiment may describe, mathematically, these correlations for an individual target product. The neural network model (including designation of the node values in the input layer, and number of layers), along with the weight matrices associated with each layer in an embodiment may form a trained machine learning classifier, algorithm, or mathematical model to be used in generating any competitive set report 898 as described herein.

As described herein, the output from the, now trained, machine learning module 896 is a competitive set report 898. With the competitive set report 898 the computing device 822 may, with the processor 810 and NID 880, determine a current performance on the search terms related to the target product that are most relevant to the competitive set defined in the competitive set report 898. In this process, the two variables that are discovered are how often a term appears in a search generally (e.g., a general search term volume, or how many times people search the term per day) and how often the term appears in searches associated with the competitive set report 898. More specifically, in an embodiment, those search terms found to be most general and similar among the target product and each competitive product are provided to the comparison module 834 which searches, via execution of the processor 810 at the search engine 894, those search terms defined in the competitive set report 898. During this process, the processor 810 may access the search engine 894 at the digital marketplace 882 or any other search engine and obtain search term metadata that describes the current performance of each of the search terms related to the target product that are most relevant to the competitive set defined in the competitive set report 898. The comparison module 834 may compare these most relevant search terms from the competitive set report 898 and provide that data to the user in the form of an actionable report 837. In some example, the data descriptive of the search terms related to the target product that are most relevant to the competitive set in the actionable report 837 may be provided to the user via a graphical representation.

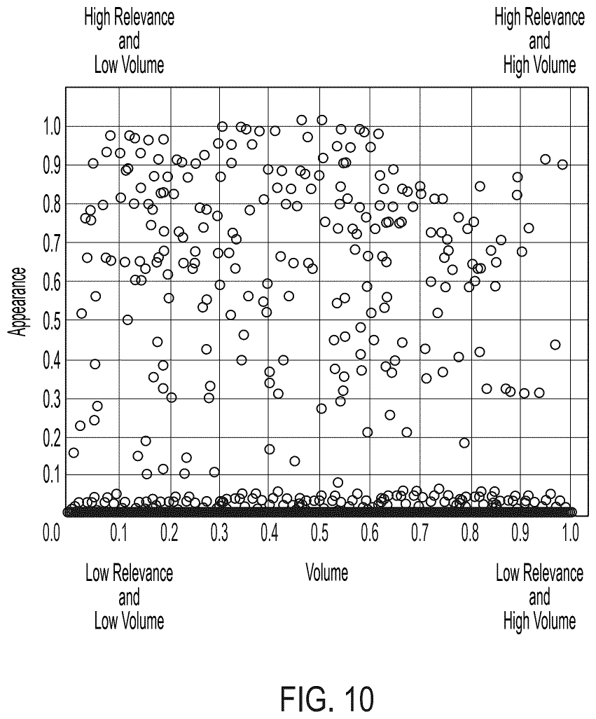

An example graphical representation of this current performance on the search terms related to the target product is shown in FIG. 10. As shown in FIG. 10, the further to the right of the graph any search term (e.g., represented by a circle) is, the search term has a higher volume or appears more often than the other search terms indicating a relatively higher relevance to competing products. Additionally, the further to the left of the graph any search term is, the search term has a lower volume or appears less often than the other search terms indicating a relatively lower relevance to competing products. Also, the further to the top of the graph any search term is, the search term has a higher relevance than the other search terms indicating a relatively higher relevance to competing products. Further as the search term is placed lower on the graph, the search term has a lower relevance than the other search terms indicating a relatively lower relevance to competing products. The most frequently search and relevant terms may be provided to the comparison module 834 as well and used to further define the sustainability and feasible growth over time of the target product on, for example, the digital marketplace 882.

With those most relevant and most frequent search terms as indicated in FIG. 10 being discovered and presented in the actionable report 837, the computing device 822 may also quantify an opportunity of those search terms that, when associated with the target product, would increase the revenue and profit margins in selling the target product. In an embodiment, the processor 810 may execute a revenue module 899 to receive those relevant and most frequent search terms from the actionable report 837 and provide output to a user in the form of an increased revenue metric. The increase revenue may be calculated by the revenue module by, upon execution of the processor 810, the following formula:

$$Increased Revenue = Impressions * Click Rate * Conversion Rate * Basket Size * Price \qquad Equation 1$$

In the context of Equation 1, the impressions may be defined as the search volume of each those most relevant and most frequent search terms in an embodiment. In an embodiment, the quantity of impressions may be measured by a number of times an ad associated with the target product is presented to any given user during or after those most relevant and most frequent search terms are entered into a search engine 894. This data may be retrieved by the processor 810 by accessing a particular database or, as described herein, accessing a search query website.

In an embodiment, the click rate of Equation 1 may be defined as an estimation along a curve of the probabilities of receiving clicks associated with the rank for each of the most relevant and most frequent search terms provided by the actionable report 837. For example, a ranking may be set to include a first place click rate (e.g., 20% of clicks), second place click rate (14% of clicks), up until a 10th place click rate (6% of clicks) and beyond to any number of ranked most relevant and most frequent search terms. This data may be retrieved by the processor 810 by accessing a particular database or, as described herein, accessing a search query website.

The conversion rate in Equation 1 may, in an embodiment, be defined as percentage of those most relevant and most frequent search terms that were clicked and associated with the target product and converted into a sale (e.g., resulted in a sale of the target product). This data may be retrieved by the processor 810 by accessing a particular database or, as described herein, accessing a search query website.

In an embodiment, the basket size may be defined as the number of units purchased with each conversion. This number may be averaged over a plurality of purchases in an embodiment. For example, where a number of conversions have been detected, the processor 810 may calculate how many units of the target product were purchased at any one time (e.g., units placed in a “shopping cart” for purchase at the digital marketplace 882). This value may at least be equal to 1 or more. Again, this data may be retrieved by the processor 810 by accessing a particular database or, as described herein, accessing a search query website.

The price of the target product may be, in an embodiment, a suggested retail price by the manufacturer. In an embodiment, the quantitative value of the price in Equation 1 is an average price of the target product across any plurality of digital marketplaces 882 net of any discounts or promotions associated with those sales. This data may be retrieved by the processor 810 by accessing a particular database, accessing a search query website as described herein, or accessing sales data from a database maintained by the manufacturer of the target product.

In an embodiment, any of the impression values, click rate values, conversion rate values, basket size values, and price values in Equation 1 may be augmented by a weight value. In this embodiment, the weight value may accentuate or abate the effect of any one of these values in Equation 1 in order to better determine an increased revenue value or opportunity by the seller of the target product to increase that revenue. Because the actual, real-time data is being used in Equation 1, the seller of the target product or user of the computing device 822 may know, in real-time, whether to take advantage of any instance of increased views or sales of a product in order to increase interest in the target product over any competitors' products.

In an embodiment, the value associated with click rate in Equation 1 may significantly shift a decision by a user of the computing device 822 whether to take an action such as provide more advertising supporting the target product. This click rate associated with improving the search rank from the target product's current position on a search term to a potential rank position of a search phrase may be weighted to accommodate for an increase in importance of this value in some embodiments. For example, for a given search term that may improve an organic search rank for any of the search terms from 20th rank to 5th rank will improve the click rate by an estimated 3 times. Some of the improvement in rank may also originate from increased impressions and especially in situation where having an unranked target product on a search term achieves a search rank 10th among the rankings. In this example, this would improve clicks from zero (due to zero impressions) to the associated estimated clicks of 10th rank on that search term. As output, the processor 810 may, via the revenue module 899, provide an increased revenue report 802 describing how to, if at all, increase the revenue related to the sales of the target product.

In some instances, some search terms are not applicable to the target product but, if applicable to the target product, may increase revenue. These currently inapplicable search terms may be referred to, in the context of advertisement, as “unattainable.” These unattainable search terms may be those search terms that are irrelevant, at least initially, to the target product for some reason or not yet associated with the target product because platform data associated with the digital marketplace 882 lacks data associated with the target product. In an embodiment, the machine learning module 896 may also be trained and used to receive data related to the characteristics of the target product, current competitors of the target product, and the current state of the ecommerce search term algorithm to determine the “winnability” of a search term. The winnability of a search term may be defined as the probability of winning each search term (e.g., having the target product associated with the search term) at any given point in time along with the estimated costs to win those search terms.

The machine learning module 896 may be trained with winnability inputs as described herein in order to provide a winnability report 804. Some of the inputs for this model included any number of inputs and the description of certain types of inputs is not meant to limit the breadth of input into the machine learning module 896 in order to obtain a winnability report and the present specification contemplates these additional and different inputs. By way of example, an input may include a current and historical price for both the target product and competitive products. This historical pricing may be retrieved from one or more digital marketplaces 882 via the execution of the processor 810 and NID 880 as described herein. In this specific example, the processor 810 may cause the NID 880 to access the one or more digital marketplaces 882 either via a wired (wired transmitter/receiver 840) or wireless (wireless transmitter/receiver 850) connection, find instances of the target product and competing products being sold, and retrieve their historic pricing values.

Another input to the machine learning module 896 may include a current and historical review ratings and review counts associated with the target product and competing products. These review ratings and review counts data may be retrieved from one or more digital marketplaces 882 via the execution of the processor 810 and NID 880 as described herein. Digital marketplaces 882 often provide a GUI that allows the consumer of the target product and competing products to enter text descriptive of the consumers' experiences with the target product and competing products as well as a ranked evaluation of those products in the form of a number rating system or start rating system. In this specific example, the processor 810 may cause the NID 880 to access the one or more digital marketplaces 882 either via a wired or wireless connection and find review ratings and review counts associated with the target product and competing products being sold, and provide that review ratings and review counts data to the machine learning module 896.

Yet another input to the machine learning module 896 may include content similarity scores of any a search term related to the target product and competing products. These scores may be generated based on the data provided, in an embodiment, in FIG. 9. For example, the further to the right any given search term is on the graph of FIG. 9, the more similar the search terms of a competitive product are similar to the search terms of the target product. In a specific example, the x-axis (bottom) of the graph of FIG. 9, or its associated data, may be used to assign this similarity score. As is shown in FIG. 9, the similarity score may be either a positive or a negative score per the number ranking on the x-axis of FIG. 9. In this example, the similarity score may be a positive weight or a negative weight reflected in the winnability report 804 provided by the processor 810 upon execution of the machine learning module 896. In this embodiment, the processor 810 may, again, cause the NID 880 to access the one or more digital marketplaces 882 either via a wired or wireless connection and retrieve the plurality of sets of target product search terms and rankings as well as a plurality of sets of competing product search terms and rankings associated with the target product and competing products being sold. This data is then provided to the machine learning module 896.

Still further, other input to the machine learning module 896 may include platform specific information such as average best seller rank (BSR) for any given digital marketplaces 882 associated with the target product and any number of competing products. A BSR may vary at any given digital marketplace 882, but these rankings may be averaged over a plurality of digital marketplaces 882 to get this value. In this embodiment, the processor 810 may, again, cause the NID 880 to access the one or more digital marketplaces 882 either via a wired or wireless connection and retrieve this BSR data. This data is then provided to the machine learning module 896.

Other input to the machine learning module 896 may include a projected search term volume and click distribution. In connection with this type of data provided to the machine learning module 896, the projected search term volume may be retrieved from the data used to create the graph in FIG. 10. This data describing how often any given search term associate with the target product and competing product appears in searches may be accessed by the processor 810 and provided as input to the machine learning module 896. Additionally, any click distribution describing how many clicks any given search term gets may be accessed by the processor 810 and NID 880 at the search engine 894 of the digital marketplaces 882.

Yet other input to the machine learning module 896 may include historical variations in search term ranks related to the target product and search phrase products. At any given time, a search engine 894 may have varying fluctuations in what is searched for on the internet. These search terms may be ranked and their historic ranking may change over time based on a number of social, political, environmental, and economic factors. This historical data may be retrieved from the search engine 894 by the processor 810 and NID 880 and provided to the machine learning module 896.

Another example input to the machine learning module 896 may include targeted advertising spending associated with the search terms associated with the target product. This data may be maintained on any database that is accessible to the processor 810 of the computing device 822. In a specific embodiment, this data descriptive of the targeted advertising spending associated with the search terms associated with the target product may be maintained by the seller of the targeted product on a private database and the user of the computing device 822 may be given secure access to that database. This type of data too may be provided to the machine learning module 896.

With all of these different types of data obtained by the processor 810 via the NID 880, the machine learning module 896 may build a number of mathematical models that provide a winnability report 804 that describes a probability of winning each search term (e.g., having the target product associated with the search term) at any given point in time along with the estimated costs to win those search terms. As with each machine learning module 896, the machine learning module 896 may be “taught” by using the winnability factors described herein. In a specific embodiment, the machine learning module 896 may implement a non-parametric and parametric learning technique. For example, the machine learning module in an embodiment may model the relationships between each plurality of sets of winnability factors using a layered neural network topology. Such a neural network in an embodiment may include an input layer (e.g., the winnability factors) including a known, recorded set of values for each of these parameters, settings, indicators, and usage data metrics, and an output layer including a projected winnability report 804, based on the known, recorded set of values in the input layer. The machine learning module 896 in an embodiment may propagate input through the layers of the neural network to project or predict an optimal winnabilities of search terms based on the known and recorded search term metrics, and compare these projected values to optimal search terms to be presented in the winnability report 804. Using a back-propagation method, the machine learning module 896, in an embodiment, may then use the difference between the projected values and the known optimal values to adjust weight matrices of the neural network describing the ways in which changes in each of the search term data metrics are likely to affect the optimal search terms to be presented in the winnability report 804.

With the output layer, the computing device 822 may provide learned competitive search terms that are determined to be the optimal search terms if any have been designated and based upon the winnable search terms detected at the search engine 894 of the digital marketplace 882 or other database during use of the computing device 822. These resulting learned optimal search terms may be suggested to a user or automatically implemented. Suggestion may come with an indicator and may be shown in a graph at a user interface for, in an embodiment, approval by the user before implementation of the other processes executed by the processor 810 of the computing device 822.

In an embodiment, the machine learning module 896 may perform a forward propagation and backward propagation, using different input node values repeatedly to finely tune any matrices either weighted or not. In such a way, the machine learning module 896, in an embodiment, may adaptively learn how changes in the winnability factors may affect the data reflected in the winnability report 804. The weight matrices associated with the layers of the neural network model in such an embodiment may describe, mathematically, these correlations for an individual target product. The neural network model (including designation of the node values in the input layer, and number of layers), along with the weight matrices associated with each layer in an embodiment may form a trained machine learning classifier, algorithm, or mathematical model to be used in generating any winnability report 804 as described herein.

As described herein, the output from the, now trained, machine learning module 896 is a winnability report 804. With the winnability report 804 the computing device 822 may, with the processor 810 and NID 880, determine a probability of attaining the desired change in revenue based on a required investment. In an embodiment, the required investment may be calculated by the following equation:

$$Required Investment = Projected Bid * ( Impressions * Clickthrough Rate ) \qquad Equation 2$$

A return on investment (ROI) may then be calculated using the following equation:

$$R O I = Increased Revenue * ( Projected Time to Remain at Required Investment ) \qquad Equation 3$$

With Equations 2 and 3 those target products with search terms with high returns on investment can then be prioritized for both advertising and search engine optimization actions by the user. In this manner, the computing device 822 may execute the machine learning module 896 for a second purpose of determine the “winnability” of a search term where additional funds are applied to advertisements and search engine optimization.

In an embodiment, the ad spend margin, ad spend potential and revenue potential calculations by the processor 810 may also be conducted to specifically determine how much additional advertising funds to apply to the target product. Again, the ad spend margin may be calculated by multiplying a target ACoS by the price of the target product. A target ACoS may be determined and set by the seller based on available capitol or may be set by the seller based on the fraction of the revenue received thus far from the sale of the target product on the digital marketplace 382 and costs of manufacturing. Ad spend potential may then be calculated by multiplying monthly opportunity units (OU) by the spend margin. The monthly OUs may be calculated as a result of the conversion rate of clicks to the target product that is the results of sales of the target product after a purchaser has viewed the product. The revenue potential may then be calculated by multiplying the OU with the price of the target product. This revenue potential of each of the target products may be ranked to determine the placement of the target product within the digital marketplace 882. The search terms presented in the winnability report 804 may be sorted by revenue potential to determine the target product's best opportunities for revenue growth. In order to refine a recommendation, the process may continue with inputting estimated bid amounts from the digital marketplaces 882 required to win advertising slots for these keywords. In this manner, the execution of the processor 810 may initiate these calculations in order to predict a number of clicks and a cost necessary to achieve the potential growth. The equation to make this calculation is found in connection with Equation 2 herein.

An ROI may further be calculated by the following equation:

$$R O I = Ad Spend Potential * ( Investment Payoff Term - Investment Needed ) \qquad Equation 4$$

As highly winnable terms are targeted in this process with both advertising and search engine optimization techniques, increasing the associated impressions, clicks, and conversions, the processing applied to the target product may continually adapt. As a target product succeeds on new search terms the competitive products set defined in the competitive set report 898 will shift to be compared to larger and less niche competing products. As the competitive products set defined in the competitive set report 898 shifts, the competitive terms set will shift as well. As reviews, terms, seller ranks, and other attributes shift, the winnability and associated required investment of each term also shifts. With the shift in winnability, new terms are prioritized and the cycle continues iteratively to cause the revenue associated with the targeted product to increase proportionally.

In some embodiments, the computing device 822 (or the system 100, the computing device 420, the computing device 520, or the computing device 322) may be configured to provide a web-based user interface which enables associates to interact with stored product data and which provides instructions to the associate about what is required to successfully complete a transaction within an overall process of order preparation and fulfillment from a vendor or brand to a marketplace warehouse environment.

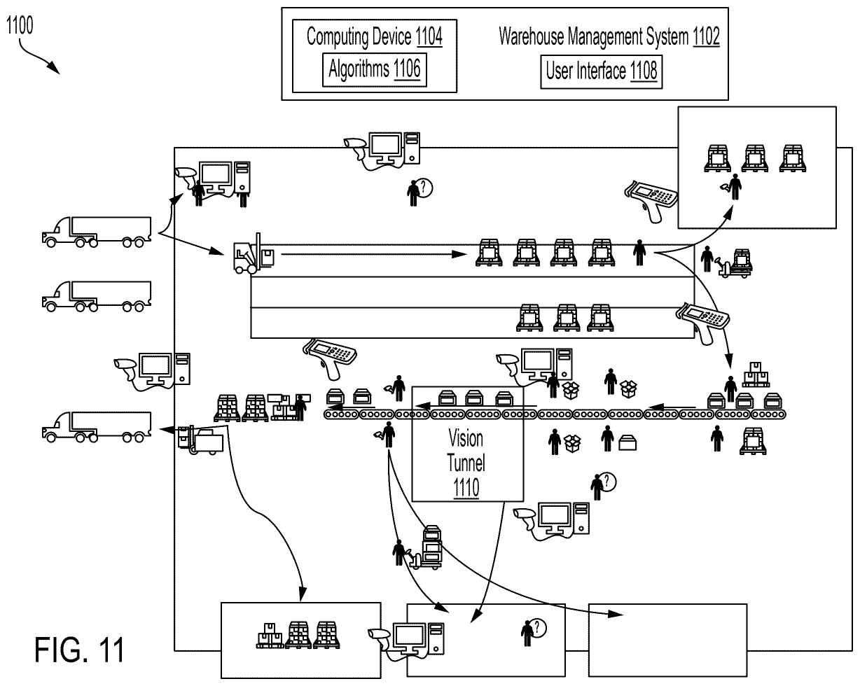

FIG. 11 illustrates various moments in time, from a delivery intake to an outbound shipment within a warehouse environment 1100, wherein a computing device 1104 of a warehouse management system 1102 may be prompted by a warehouse associate within the warehouse to complete decision-making tasks in order to provide streamlined processing of marketplace items and cartons within a warehouse setting.

The user interface 1108, implemented using computing device 1104, may be used to guide or to otherwise instruct the associates through the warehouse processes and gather data to pass to the marketplace. Gathering data may include receiving data that is input by the associates into the user interface, such as acknowledgement that a task has been completed, acknowledgement that the associate is going to source an answer from a manager, or any other inputs from an associate, such as an indication that the task cannot be completed as suggested or that the task needs to be completed using another pathway. Moreover, computing device 1104 may be configured to combine instructions from work orders with product catalog data, such as marketplace prep instructions, in order to provide step-by-step instructions to the warehouse on how to handle items throughout the processing for marketplace shipping.

Within the following description provided herein, various tasks that are managed by systems and methods described herein may refer to tasks that are performed within a warehouse environment, or within any other environment pertaining to logistical movements of items, products, and cartons for digital marketplaces. An example of such a warehouse environment is shown in FIG. 11, wherein various tasks, sequential orderings of various tasks, capabilities or limitations of various tasks, and other performance-based metrics of such tasks are customized by the systems and methods described herein for a specific warehouse environment 1100. For example, at various moments in time illustrated in FIG. 11, an associate may approach the web-based user interface 1108 for a “problem solve,” and then wait to receive instructions from computing device 1104 via the web-based user interface 1108.

In some embodiments, a culmination of the various decision-making process steps provided by computing device 1104 may be described herein as a directed, data-driven, flow process for marketplace item(s) and carton(s) preparation. Computing device 1104 may be configured to provide data-driven task assignments to associates such that the directed flow process is scalable, rather than being reliant on localized knowledge, and automated, rather than manually driven by various associates.

In some embodiments, system-directed process steps and pathways towards fulfilment rely on internally maintained data to drive logic-driven decision-making. For example, a first step in selling a product may be to have the marketplace generate a unique marketplace identifier, such as a Stock-keeping Unit (SKU), for the product. The system may integrate with a vendor's marketplace connection via that marketplace's API. Once the integration is complete, data about each SKU may be generated and stored within one or more computing devices of the system (e.g., within a database architecture for storage). Among other information, stored data may include item-level information, such as a Universal Product Code (UPC), prep requirements, dimensions, weights, pictures, etc., and carton information, such as units per carton, carton label data, carton dimensions, etc. Such data may then be used and/or otherwise referenced by the system at various moments in time in order to complete tasks within the differentiated associate experience and directed flow process.

In some embodiments, providing the system with such types of data enables the system to provide instructions for various warehouse-based tasks from a centralized and more global viewpoint that is also customized for a given warehouse environment. Moreover, a web-based user interface enables associates to interact with the stored data via the system. As associates provide information about a current issue or question, the system provides back instructions about what is required to successfully complete the transaction. The system 1102 with web-based user interface 1108 may additionally be configured to instruct associates throughout an overall fulfillment process, while also gathering data to provide to a given digital marketplace. Such embodiments may include instances where the system is configured to interact with computing devices of the digital marketplace via edge computing devices.

As further illustrated with the depictions of interactions between associates and the web-based user interface in FIG. 11, the system may be configured to direct an associate to an inventory manager in order to make a given task-related decision/solution, according to some embodiments. In other embodiments, the system may be configured to determine a solution for a task based on data about a given product, moment in time within the fulfillment process for said product, etc. Such a determined solution by the system may include providing directions to the associate about how to complete a task.

Illustrations within FIG. 11 also demonstrate directions provided by the system to use conveyors or scanners, which may provide additional information to the system, enabling the system to make subsequent decisions about fulfillment tasks. For example, the system may determine that a given product is heavy enough to pose potential health risks to an associate if they are to pick up the product, and thus the system may instruct the associate to use a conveyor belt to transport the product from a first point to a second point in the warehouse. Within a given warehouse environment 1100, inventory movements may be automated for associates by the system and transactions between the system and the specific marketplaces (shipment creation) may be generated by the system. Such system-directed decision-making may reduce potential human errors or other delays by instead relying on the end-to-end viewpoint of the data-driven system.

In some embodiments, work orders, combined with product catalog data, enable the system to provide such automated solutions. For example, the system may receive information pertaining to a work order that includes instructions about what should happen to a given item once the item arrives at the warehouse. Based on that received information, the system determines where the product should be sent and in what quantities. Work orders herein may include any information pertaining to the item, such as a listing ID corresponding to the item, SKU, marketplace, vendor, seller account, the expected quantity to ship in, or any combination of such information that may aid the system in determining pathways towards fulfillment. Moreover, if an item arrives at the warehouse without an associated work order, the system may determine that it should be sent to storage until further information pertaining to the item is received.

In some embodiments, work orders may also be accessed, via the web-based user interface 1108, by associates of an inventory team to aid in the direction of work at the warehouse (e.g., assign a given associate to a task, etc.) and ensure that items are maintained within the right node of an overall supply chain network. Said inventory team may also be knowledgeable about requirements for a given digital marketplace or for other business logic of the given digital marketplace, and may also provide such information to the system 1102 via the web-based user interface 1108. The system may also combine instructions that may be provided within work orders with other product catalog data, such as marketplace prep instructions, in order to provide step-by-step instructions to the warehouse on how to handle the items within the given warehouse environment.

In some embodiments, the computing device 1104 may be configured to perform functions that allow for various components of the system to function throughout a period of time from intake to outtake within a warehouse environment.

To track shipments and associate a purchase order (PO), the following actions may be driven by the system. In a given example, a purchase order or inventory request is placed with a given brand to request a product shipment. The shipment may then be assigned a unique ID, which may be referred to herein as an Inbound Shipping Label (ISL). The shipment is then associated with the PO(s) or inventory request(s) that are expected on that shipment. Pallets from the shipment may be broken down to the carton level and labeled with that ISL, such that each carton within the shipment is traceable to the shipment it was received on. Each labeled carton may then be placed on a conveyor belt that is directed towards a receiving station.

To receive the cartons and prepare the marketplace, the units may be verified and the quantity of items counted. The receiver logs such information into the web-based user interface, scans a station for tracking purposes, then pulls a carton off of the conveyor. The associate scans the ISL such that the information is provided to the system, opens the carton, and scans an item in the carton such that the information is provided to the system. Upon that scan, the system may determine the item the barcode corresponds to and/or any link to any PO on the ISL, further determine a work order associated with the PO/item combination, and generate any preparation requirements for that SKU as determined by the given digital marketplace. The system then causes the web-based user interface to display specific step-by-step marketplace preparation instructions for the associate. In addition, the system may cause any item-level labels, if required, to be printed at a station that corresponds to the screen of the web-based user interface (see also FIG. 11). When the associate has completed the item-level preparation, the system may then cause the web-based user interface to provide instructions to the associate to collect carton-level weights and dimensions. In some embodiments, the web-based user interface may provide pre-filled instructions or suggest expected responses to the associate based on requirements that are specific to the given digital marketplace that the associate might use. Once the associates has confirmed or entered the carton-level information, they place a globally-unique warehouse management system carton label (PCL) on the carton and place it on a takeaway conveyor.

As indicated in the previous example, the given associate does not require context of a final destination of the product that they are currently processing, as instructions are provided by the system which has an end-to-end viewpoint. Once the carton leaves the receiving station, the system may continue to provide instructions and directions to associates, and/or conveyors or other warehouse environment machines based on the work order information. In some embodiments, the system is configured to interact, via an API, with the digital marketplace. Furthermore, the PCL is associated with the SKU and its contents and the PCL are placed into a virtual queue of other items from other vendors and accounts. At a designated time interval, the information is batched together and sent to the marketplace for shipment plan creation. Such a sending to the marketplace may comprise one or more API calls in which data is sent back and forth. For example, the system may provide, via the API, information about what cartons, sizes, products and quantities will be sent. The system may then receive, from the marketplace, shipping instructions and labels for each carton within the shipment. The shipping label that is received from the marketplace may be referred to herein as a Marketplace Carton Label (MCL), and may contain a serialized, globally unique identifier and/or any other externally recognized number for each carton as determined by the marketplace. This external number is then stored in storage devices of the system and is associated with the carton's internal PCL. In some embodiments, such processing steps, as coordinated by the system, are performed prior to reception of the carton at a carton labeling station.

In some embodiments, the system may then coordinate the addition of the shipping label to the carton, wherein an associate scans the PCL into the web-based user interface, and the system then causes the web-based user interface to print the associated MCL. The associate then applies the MCL on the carton. As previously described above, the MCL contains the carton contents, the shipment identifier, and destination fulfillment center for the marketplace printed on it. The carton may then continue along the conveyor belt within the given warehouse environment towards the outbound dock. While on the conveyor, the carton may be scanned, weighed, and measured, and such corresponding information may be received by the system. Using the MCL on the carton, the system also determines the destination for the carton and causes the carton to be directed and/or diverted accordingly down a conveyor toward a truck with the same, consolidated destination from other vendors and accounts. Next, the carton is loaded directly into the truck which will be sent on to the marketplace fulfillment center or cross dock operation. In some embodiments in which a given warehouse environment is not equipped with conveyor belts, a directed pallet built process ensures cartons are grouped by final destination. The pallet building tool allows an associate to scan the carton, see other pallet locations headed for the same end location, and add the carton to that outbound pallet. Pallets are marked closed and labeled with a unique ID as they are filled. Those unique IDs are then scanned onto an outbound LTL or FTL shipping group as they are physically placed on the outbound truck. After shipment preparations have been made, transportation to premises of the given digital marketplace may be additionally coordinated by the system, such as via an API.

As illustrated using the above description and examples, the systems and methods described herein provide a high-volume, low-defect processing technique which enables logistical tasks related to preparation and shipping to be conducted more efficiently and with less error. The data-driven system that determines processing steps to direct associates and/or machines within the warehouse towards fulfillment allows for fewer potential injuries within warehouse environments while also optimizing fulfillment. Such optimizations thus lead to improved optimization and mechanical capacities of warehouses as well.

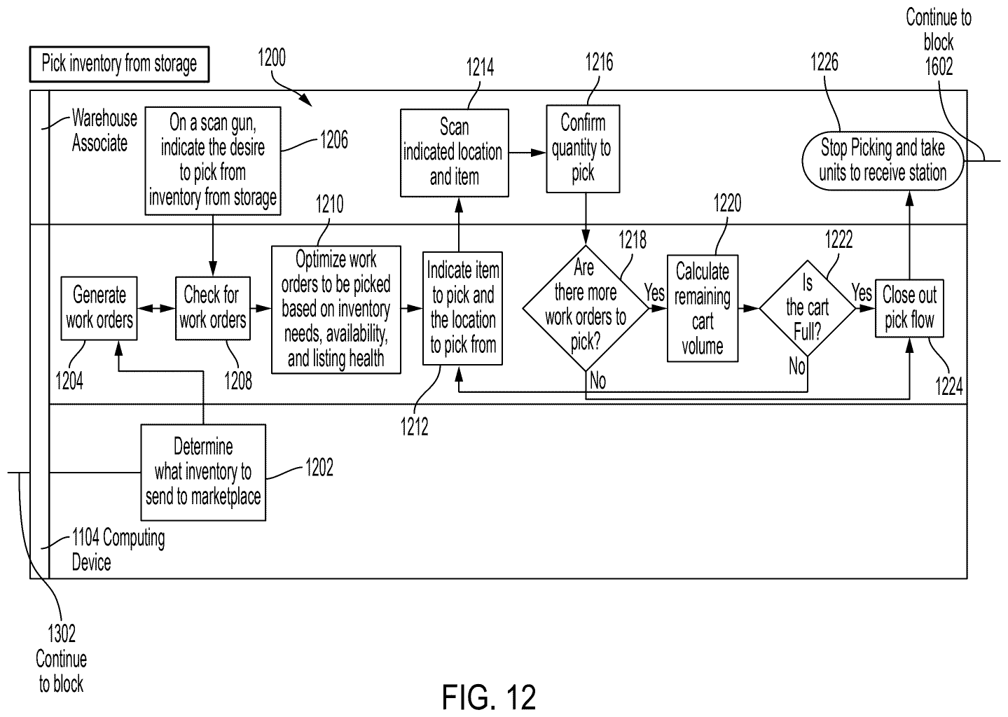

FIG. 12 is a flow diagram that illustrates interactions between a warehouse management system and a warehouse associate regarding selection of inventory from storage within the warehouse environment, according to some embodiments.

Process 1200 begins with block 1202, wherein computing device 1104 determines what inventory should be sent to a marketplace. The marketplace, from warehouse environment 1100, represents a location in the warehouse environment 110 that is designated for outbound marketplace shipments. The determination that is illustrated in block 1202 is additionally described with regard to process 1300 below.

After the determination is made, computing device 1104 is further configured to generate work orders, as shown in block 1204. In block 1206, a warehouse associate indicates, via user interface 1108, that it is time to select inventory from storage, and computing device 1104 subsequently checks for pending work orders in block 1208.

In block 1210, the pending work orders are optimized based on inventory needs of the marketplace, availability, and listing health (e.g., age since a listing has been initiated on a marketplace website).

In block 1212, computing device 1104 indicates an item selection and provides information to a handheld device regarding where to pick up the item or some other form of identifying the item's location within warehouse environment 1100. The warehouse associate then scans the location and item and confirms that the intended quantity items is as expected in blocks 1214 and 1216.

In block 1218, computing device 1218 verifies whether there are additional work orders to be handled at this moment in time. If yes, then, in block 1220, a remaining volume of a nearby cart is calculated. If the cart is not full, in block 1222, then the computing device 1104 indicates that more items should be selected (e.g., in block 1212), and the process iterates until there is no remaining volume in the cart. In block 1224, the selection of items is closed, and computing device 1104 indicates, via the handheld device, that the warehouse associate has completed the task. In block 1226, the warehouse associate is instructed by computing device 1104, via the handheld device, to physically move the items to a receive station, and the process continues with block 1602, which is additionally described below.

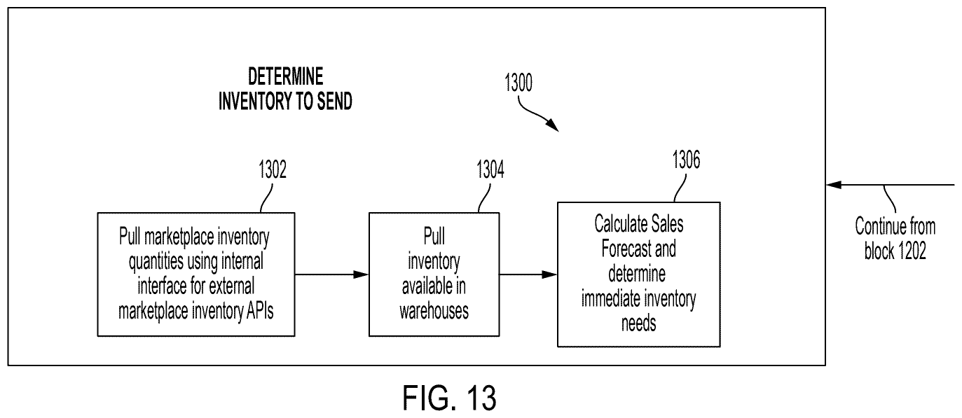

FIG. 13 is a flow diagram that illustrates a process 1300 of determining what portions of the inventory to send to a marketplace, according to some embodiments.

In some embodiments, FIG. 13 illustrates an example of one of algorithms 1106 that is executed by computing device 1104.

In block 1302, warehouse management system 1102 is configured to source marketplace inventory quantities using an internal interface of a database configured for external marketplace inventory APIs.

In block 1304, computing device 1104 is configured to determine what, if any, inventory is available in warehouse environment 1100.

In block 1306, computing device 1104 is configured to calculate a sales forecast, and use that sales forecast to determine more concerning or aged inventory needs.

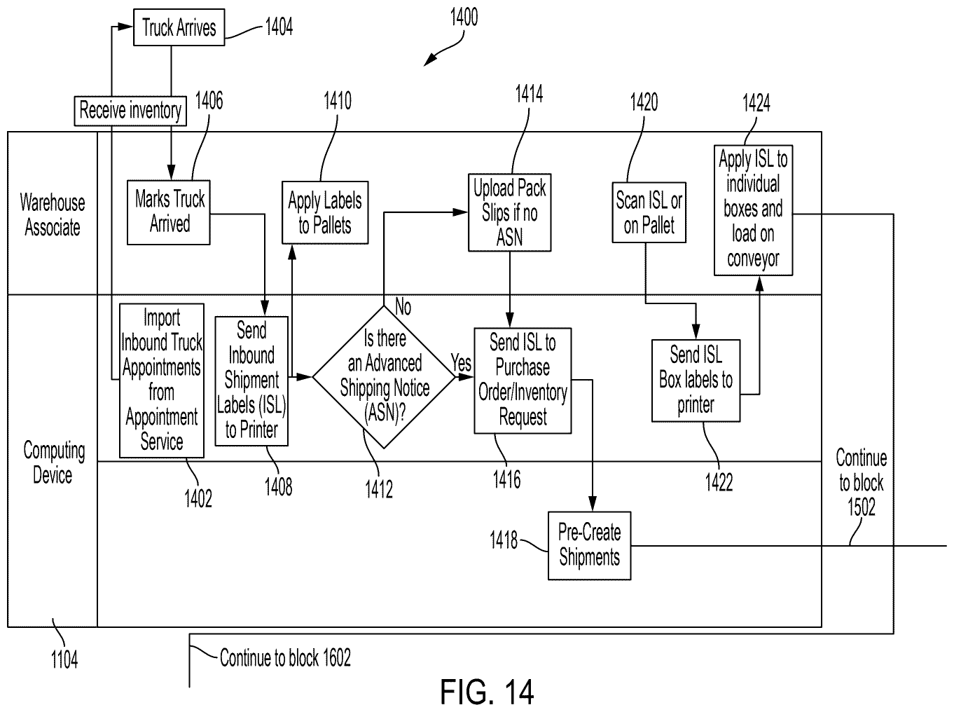

FIG. 14 is a flow diagram that illustrates a process 1400 of receiving inventory to the warehouse environment and subsequently processing the intake of inventory, according to some embodiments.

In block 1402, computing device 1104 is configured to import upcoming inbound truck appointments from an appointment service with regards to warehouse environment 1100.

In block 1404, a truck arrives to warehouse environment 1100.

In block 1406, a warehouse associate provides an indication, via a handheld device, to computing device 1104 that the truck has arrived. In response, computing device 1408 causes inbound shipment labels (ISLs) to be printed. Then, the warehouse associate applies the labels to pallets in block 1410.

In block 1412, computing device 1104 determines whether or not an Advanced Shipping Notice (ASN) exists for the shipment. If no, then computing device 1104 provides instructions to the warehouse associate, via the handheld device, to upload pack slips, as shown in block 1414.

After the pack slips have been uploaded or otherwise determined, computing device 1104 links an ISL to a given purchase order or inventory request in block 1416. In response, computing device 1104 also generates shipment pre-creation statements in block 1418, which is also further described with regards to process 1500 herein.

In block 1420, the warehouse associate scans an ISL or some other indicator on a pallet, wherein the corresponding information is then sent via the handheld device to computing device 1104. Computing device 1104 then causes the ISL box labels to be printed in block 1422. Then, the warehouse associate applies the ISLs to individual boxes and loads the boxes onto a conveyor in block 1424, wherein the conveyor takes the boxes to another location within warehouse environment 1100.

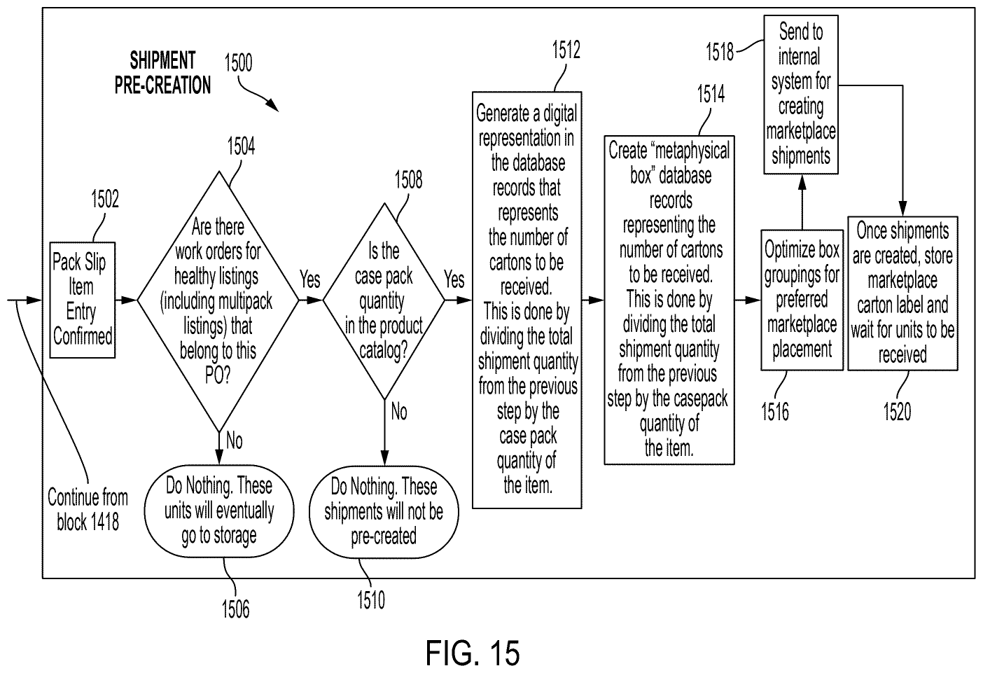

FIG. 15 is a flow diagram that illustrates a process 1500 of generating shipment pre-creation statements, according to some embodiments.

In some embodiments, FIG. 15 illustrates an example of one of algorithms 1106 that is executed by computing device 1104.

In block 1502, computing device 1104 is configured to confirm entry of a pack slip item. In block 1504, computing device 1104 determines whether or not the corresponding work orders relate to healthy listings that belong to a given purchase order. If no, then units should go back to storage, as indicated in block 1506, and computing device 1104 transmits this instruction to the warehouse associate via the handheld device. If yes, then computing device 1104 determines, in block 1508, whether the case pack quantity exists in the product catalog. If no, then units should go back to storage, as indicated in block 1510, and computing device 1104 transmits this instruction to the warehouse associate via the handheld device. If yes, then computing device 1104 calculates a shipment quantity.

In some embodiments, a case pack is a larger unit that comprises individual products, items, or other units. For example, one “case pack” of pencils may include twelve individual pencils, wherein the individual pencils are base item units.

The shipment quantity may be calculated by determining a minimum of pack slip quantities and remaining work order quantities. Computing device 1104 also accounts for multipack work orders as well during this calculation.

In block 1514, computing device 1104 is configured to generate a metaphysical box within database records of the warehouse management system 1102, wherein the “metaphysical box” database records represents a number of cartons to be received. The number of cartons to be received may be determined by dividing a total shipment quantity, determined in block 1512, by the case pack quantity of the given item.

In some embodiments, a metaphysical box may also be referred to as a digital twin, a digital representation, etc. The digital representation of the box includes metadata, information, and other parameters about a physical box or case pack that it corresponds to. For example, the digital representation represents a planned physical box that will be physically constructed with a given number of items and cartons and according to existing work orders. The digital representation is associated with metadata, including a quantity of items that will be placed into the physical box, dimensions of respective ones of the items and thus, by extension, physical space remaining in the box if those respective items were to be placed into the box, a weight of the box both before and after placing the respective items into the box, etc. In some embodiments, additional metadata associated with the digital representation may include both case pack information and information about items within a case pack. Continuing with the example introduced above, the metadata associated with the digital representation may comprise dimensions, weight, and quantity of the case packs that are to be placed into the physical box, and also dimensions and weight of individual items within each case pack. In such examples, a digital representation may thus include a partial case pack, wherein six pencils from a total of twelve pencils in a case pack are applied to the digital representation in order to fill a box to completion based on expected amounts of empty space remaining in the physical box and/or according to weight restrictions of the physical box.

In addition, the digital representation may include parameters associated with the intended methods of packaging the physical box that pertain to the work orders themselves and/or to general warehouse guidelines. For example, a weight restriction may be placed onto the physical box via parameters of the digital representation, wherein a physical box of XYZ dimensions is not to exceed N pounds. In another example, certain items within a box will risk being crushed by heavier items if a total number of items within a box are stacked incorrectly or in some other non-optimized way. Parameters associated with the digital representation may therefore include indications that certain items or case packs should be packed into an upper half of the physical box to avoid damaging the products, or that certain items or case packs should be packed in a lower half of the physical box due to the items being above a given threshold weight.

Any of the information, metadata, or parameters that are initially associated with a digital representation at a moment in time depicted by block 1514 may later be updated for any number of reasons. Examples of those updates and those reasons are additionally described with regard to blocks 1604, 1606, 1608, 1624, and 1626 herein.

Furthermore, at a moment in time depicted by block 1514, a digital representation, or metaphysical box, is generated using case pack quantities that are determined by the product catalog of the warehouse management system 1102. For example, the product catalog may have information already stored about a number of items that are expected to be within a case pack (e.g., twelve pencils are expected to be within one case pack of pencils), and that information is linked to a given digital representation upon generation of the given digital representation. If, at a later moment in time, a warehouse associate determines that there are actually more or less items within a given case pack than expected (e.g., there are eleven pencils in that particular case pack, rather than the expected twelve), then the metadata of the digital representation may be updated accordingly. As such, the process of generating and then utilizing a digital representation at various moments in time is a dynamic process. Additional examples of such later moments in time are discussed with regard to blocks 1604, 1606, 1608, 1624, and 1626 herein.

In block 1516, computing device 1104 then optimizes box groupings for preferred marketplace placements. In block 1518, an internal system is then sent the marketplace shipment records.

In block 1520, computing device 1104 is configured to store the marketplace carton labels and mark a passage of time until units are received.

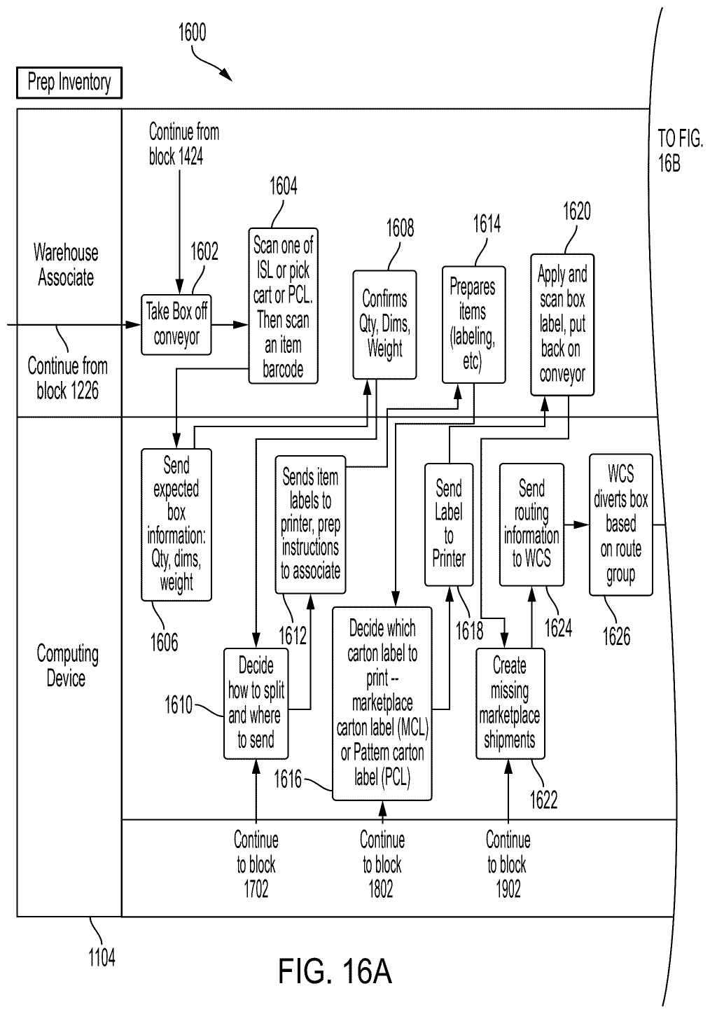

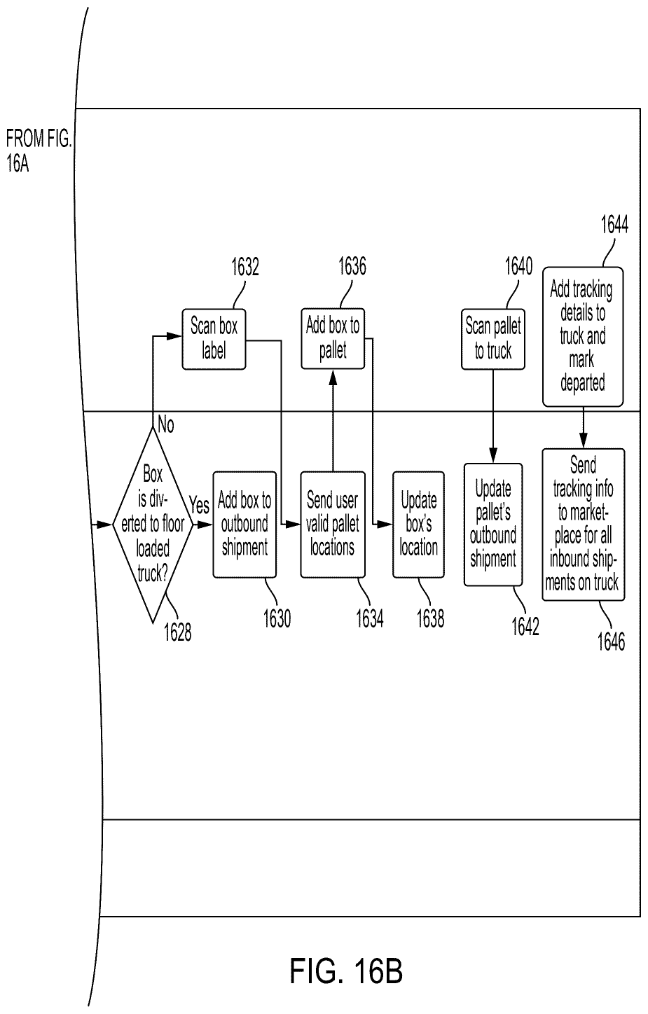

FIGS. 16A and 16B are flow diagrams that collectively illustrate a process 1600 of preparing items within the inventory for shipment outside of the warehouse environment, according to some embodiments.

In block 1602, a box is removed from the conveyor by a warehouse associate. In block 1604, the warehouse associate scans a given ISL, causing the information associated with the ISL to be transmitted, via the handheld device, to computing device 1104.

In block 1606, computing device 1104 then provides data regarding a quantity of items within the box, dimensions of the items within the box, and the weight of the items within the box to the warehouse associate via the handheld device. The warehouse associate then sends a confirmation, via the handheld device, that the quantity, dimensions, and weight match in block 1608.

In block 1610, computing device 1104 determines a subset of work orders from a plurality of work orders to sort the respective ones of the items within the box into. This process is additionally described with regard to process 1700 herein.

In block 1612, computing device 1104 is configured to provide an indication of the sorted items and the subset of work orders to the handheld device and to send item-specific labels to be printed based on association with the subset of work orders.

In block 1614, the warehouse associate then prepares the items by labeling them using the item-specific labels.

In block 1616, computing device 1104 is configured to determine a type of carton label to be printed for respective ones of the subset of work orders, wherein a first type of carton label is a marketplace shipping label and a second type of carton label is a warehouse management system type of carton label. This process is additionally described with regard to process 1800 herein.

In response to the execution of process 1800, computing device 1104 causes either the first or the second type of label to be printed, as indicated by block 1618. In block 1620, the warehouse associate applies and then scans box labels, and places the boxes back onto the conveyor.

In block 1622, the items are organized into an outbound marketplace shipment. This process is additionally described with regard to process 1900 herein.

In blocks 1624 and 1626, computing device 1104 is configured to send routing instructions to the handheld device, wherein the routing instructions provide instructions to route the respective ones of the items towards a location in the warehouse environment 1100 that is designated for a truck being loaded for the outbound marketplace shipment.

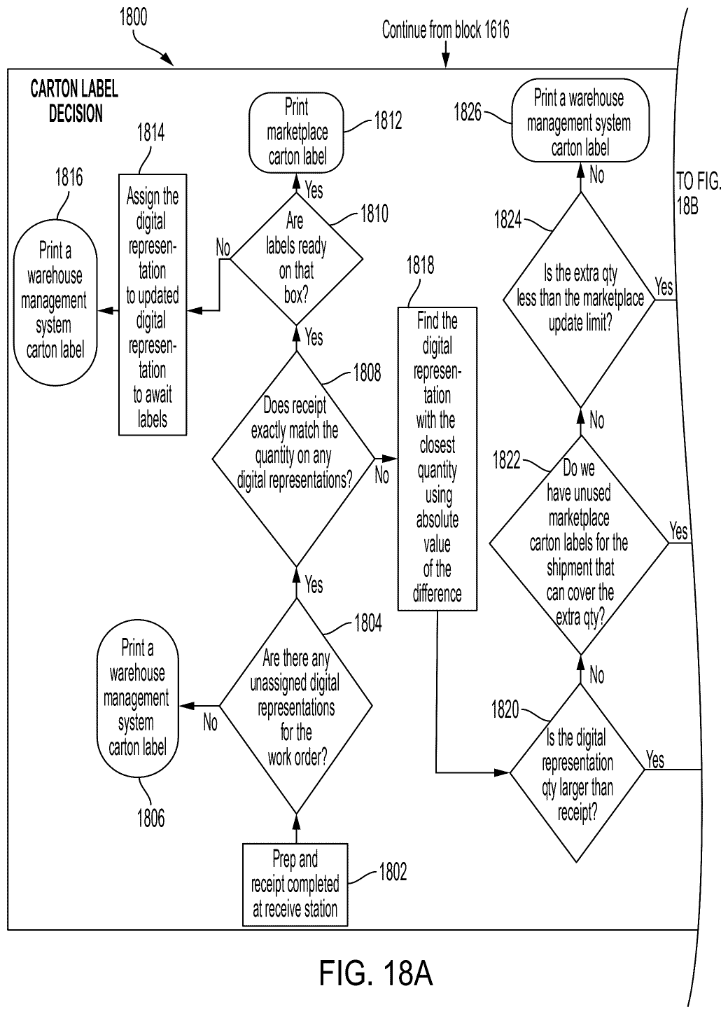

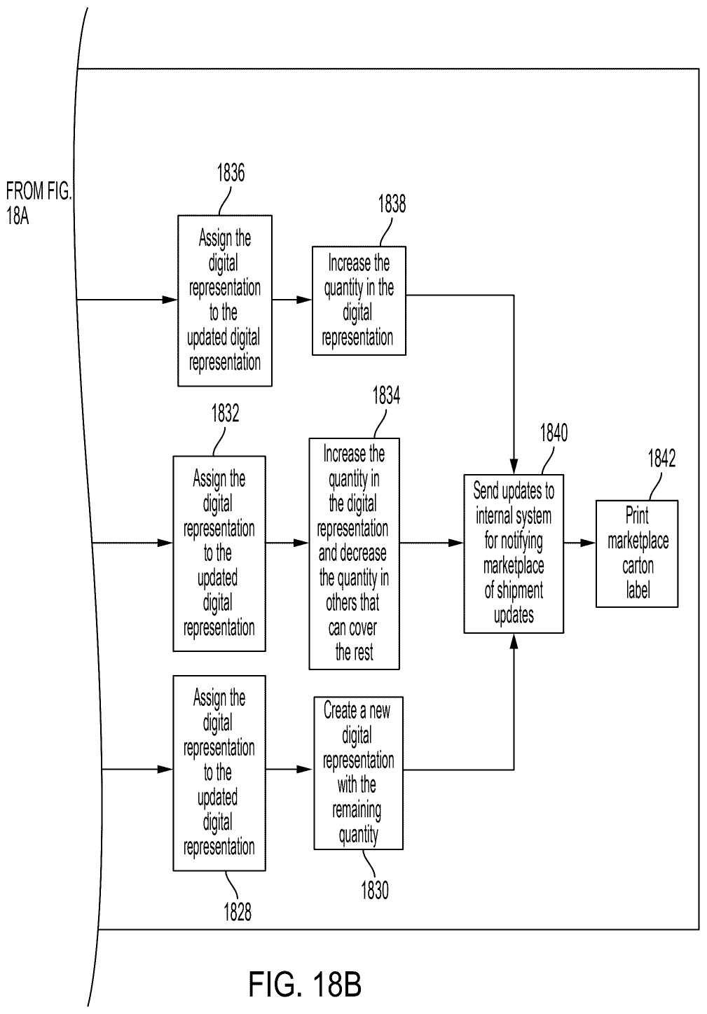

In some embodiments, actions performed in blocks 1624 and 1626 include the use of a vision tunnel, such as vision tunnel 1110. Vision tunnel 1110 is configured to scan the label, either the MCL or PCL that is determined based on a process that is additionally described below with regard to FIGS. 18A and 18B, and then dynamically determine which truck to cause the box to be routed to. In some embodiments, this includes sending program instructions to computing device 1104, wherein the program instructions include a path that the box should take along remaining portions of the conveyor belt in order to arrive at the designated truck. Computing device 1104 then instructs one or more other components within warehouse environment 1100, such as actuators, in order to cause the box to be routed along the intended path.

In some embodiments, vision tunnel 1110 includes various sensors, such as one or more cameras, video sensors, radar sensors, LiDAR sensors, ultrasonic or other motion sensors, weight sensors, temperature sensors, optical sensors, etc. The sensors of vision tunnel 1110 are configured to provide, either directly or indirectly, collected data samples to computing device 1104. Using the collected data samples, computing device 1104 then compares image-based data samples, weight information, and other parameters associated with the box to metadata and parameters associated with the digital representation. In some embodiments, a quantity of items within the box, dimensions of the box and items within the box, and weight of the box match, or are within a given threshold of matching, the source of truth that is being logged by the digital representation. In other embodiments, if any of those variables are outside of a threshold, the metadata associated with the digital representation is updated. The threshold itself may be adjustable as well, in order to provide configurable and dynamic quality checks within an overall warehouse environment 1100. For example, a single warehouse environment 1100 may be shipping items to at least a first premises of a first marketplace, a first premises of a second marketplace, etc. The thresholds may then be adjusted based on computing device 1104 determining that a given box is being loaded for an outbound marketplace shipment to the first marketplace premises, vs the next box on the conveyor belt being intended for an outbound marketplace shipment to the second marketplace premises, etc.

In other embodiments, if any of those variables are outside of a threshold, the box is routed along a certain path and a warehouse associate is alerted, via a handheld device, to further inspect the box and determine how to proceed. Moreover, computing device 1104 is configured to track a number of times that boxes have one or more variables that are outside of one or more thresholds. After a given number of times that boxes are measured and one or more variables are outside of one or more thresholds (e.g., a given number of failures have occurred), computing device 1104 is further configured to update information within the product catalog, such that values, numbers, identifications, etc. align with actual readouts from vision tunnel 1110.

The use of vision tunnel 1110 pertains to a quality check that eliminates the incorporation of possible human errors. By firstly calibrating vision tunnel 1110 and then secondly processing respective ones of the boxes within warehouse environment 1100 through vision tunnel 1110, boxes are compared against the same metrics, one after the other. Computing device 1104 is also configured to receive program instructions from an interface of vision tunnel 1110, such as via a warehouse control system (WCS) interface.

Furthermore, by updating the digital representation according to the measurements taken by vision tunnel 1110, more accurate weight, size, and quantity information is then used by computing device 1104 to determine a more optimized way to load trucks that are being loaded for outbound marketplace shipments. For example, if, when a digital representation is generated in block 1514, a weight of a physical box is expected to be X pounds, but, when later weighed by vision tunnel 1110, a total weight of the packed box is X-Y pounds, computing device 1104 may then be configured to add an additional box that weighs Y pounds to a given truckload. Such dynamic and configurable operations within warehouse environment 1100 are based on the use of a digital representation that is updated at various moments in time shown in FIGS. 12-19, thus allowing computing device 1104 to reconfigure downstream tasks based on each update.

Blocks 1628, 1630, 1632, 1634, 1636, 1638, 1640, 1642, 1644, and 1646 then describe additional interactions between computing device 1104 and the warehouse associate, via the handheld device, in order to process the outbound marketplace shipment.

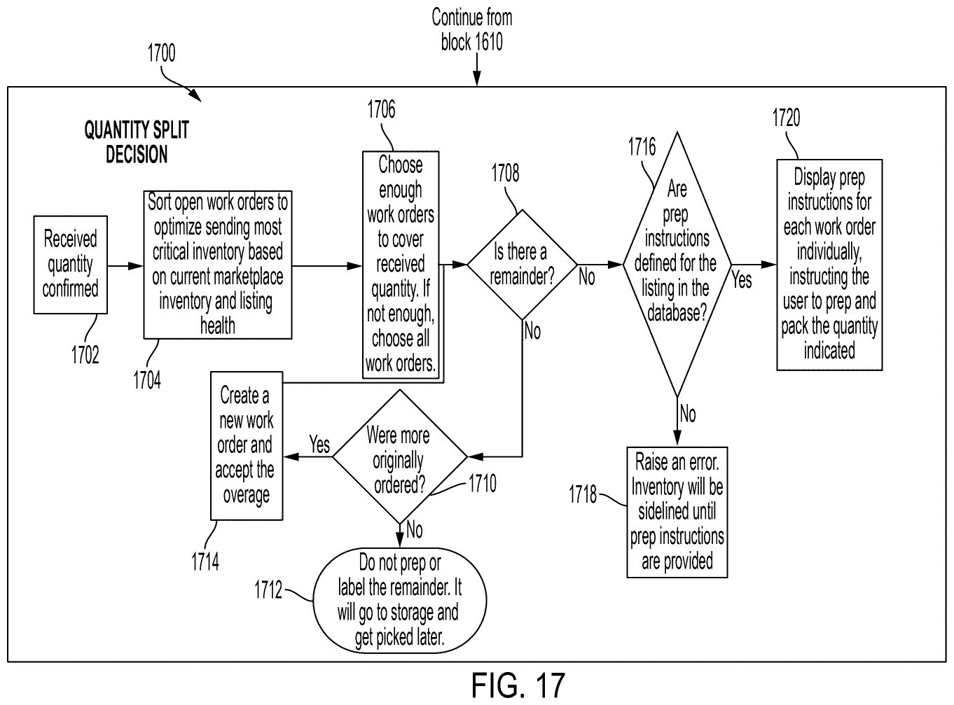

FIG. 17 is a flow diagram that illustrates a process 1700 of splitting quantities with regards to work orders, according to some embodiments.

In some embodiments, FIG. 17 illustrates an example of one of algorithms 1106 that is executed by computing device 1104, namely process 1700.

In block 1702, a quantity that is received is confirmed. In block 1704, computing device 1104 is configured to sort open work orders, such that more critical inventory is sent first, based on current marketplace inventory and on listing health.

In block 1706, computing device 1104 is configured to select enough work orders such that the received quantity is covered. In some embodiments, this is a large amount of received work orders, while in other embodiments, this is a small amount of received work orders.

In block 1708, computing device 1104 is configured to determine whether additional work orders remain. If yes, then computing device 1104 determines whether more orders were originally made. If no, then the units should go back to storage, as indicated in block 1712, and computing device 1104 transmits this instruction to the warehouse associate via the handheld device. If yes, at the decision point indicated by block 1710, then an additional work order is generated in block 1714, and the process continues until no space remains.

In block 1716, computing device 1104 searches for specific preparation instructions for a given listing via a database. If no specific preparation instructions exist, computing device 1104 transmits this instruction to the warehouse associate via the handheld device, as indicated in block 1718. If yes, then computing device 1104 transmits the preparation instructions for respective work orders to the warehouse associate via the handheld device, as indicated in block 1720.

FIGS. 18A and 18B are flow diagrams that collectively illustrate a process 1800 of determining which type of carton label to print for respective boxes, according to some embodiments.

In some embodiments, FIGS. 18A and 18B illustrate an example of one of algorithms 1106 that is executed by computing device 1104.

In block 1802, computing device 1104 is configured to receive proof of completion at the receive station within warehouse environment 1100.

In block 1804, computing device 1104 determines whether or not there is an unassigned digital representation for the subset of work orders. If no, then computing device 1104 causes the warehouse management system type of carton label to be printed, as indicated in block 1806.

If, instead, computing device 1104 determines that an unassigned digital representation does match the quantity of items within the box, then computing device 1104 then determines whether or not the inbound shipping label has already been printed on the unassigned digital representation, according to block 1808. If yes, then computing device 1104 determines whether labels are ready for that particular box, as indicated in block 1810. If yes, then computing device causes the marketplace shipping label to be printed, according to block 1812. If no, then computing device 1104 causes the warehouse management system type of carton label to be printed, according to blocks 1814 and 1816.

Returning now to blocks 1808 and 1818, if computing device 1104 determines that the unassigned metaphysical box does not match the quantity of items within the box, wherein the unassigned digital representation has a larger quantity than the quantity of items within the box, then computing device 1104 assigns the unassigned digital representation to a transient box, otherwise referred to as an updated digital representation, causes an additional digital representation to store remaining ones of the quantity of items, and causes the marketplace shipping label to be printed, as indicated by blocks 1820, 1828, 1830, 1840, and 1842.

Returning now to blocks 1808 and 1818, if computing device 1104 determines that the unassigned digital representation does not match the quantity of items within the box, wherein the unassigned digital representation has a smaller quantity than the quantity of items within the box, then computing device 1104 assigns the unassigned digital representation to a transient box, causes a quantity of items within the transient box to be increased, and causes the marketplace shipping label to be printed, according to blocks 1820, 1822, 1832, 1834, 1840, and 1842.

Returning now to blocks 1808 and 1818, if computing device 1104 determines that the unassigned digital representation does not match the quantity of items within the box, wherein the unassigned digital representation has a smaller quantity than the quantity of items within the box, then computing device 1104 assigns the unassigned digital representation to a transient box, causes the smaller quantity of items within the unassigned digital representation to be increased, and causes the marketplace shipping label to be printed, according to blocks 1820, 1822, 1824, 1836, 1838, 1840, and 1842.

Returning now to blocks 1808 and 1818, if computing device 1104 determines that the unassigned digital representation does not match the quantity of items within the box, wherein the unassigned digital representation has a larger quantity than the quantity of items within the box, then then computing device 1104 causes the warehouse management system type of carton label to be printed, according to blocks 1820, 1822, 1824, and 1826.

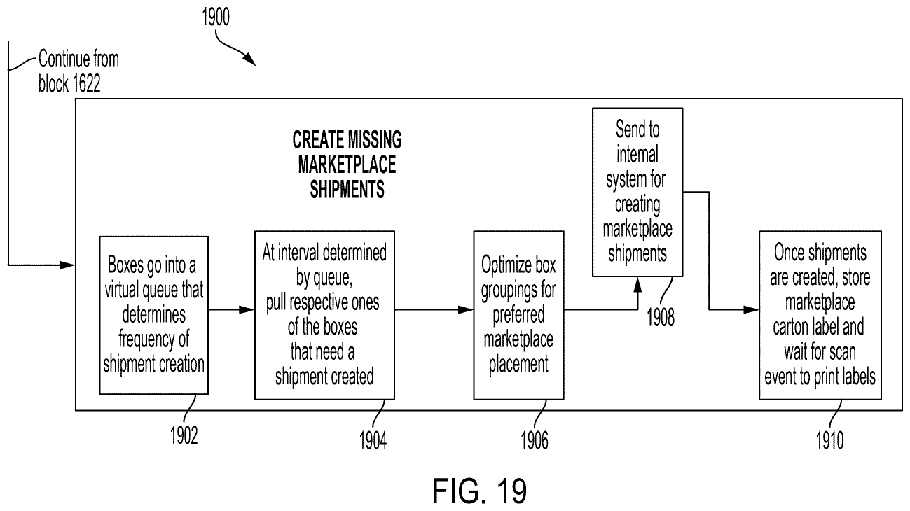

FIG. 19 is a flow diagram that illustrates a process 1900 of generating missing marketplace shipments, according to some embodiments.

In some embodiments, FIG. 19 illustrates an example of one of algorithms 1106 that is executed by computing device 1104.

In block 1902, boxes are placed into a virtual queue that is then used to determine a frequency of shipment creation. Then, in block 1904, and according to some predetermined interval of time that is based, at least in part, on the virtual queue, boxes are removed from the queue in order to generate a shipment.

In block 1906, box groupings are optimized based on preferred marketplace shipments.

In block 1908, computing device 1104 communicates with the internal system for generating marketplace shipments. Then, in block 1910, marketplace carton labels are stored.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, FIG., or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. Elements recited in means-plus-function format are intended to be construed in accordance with 35 U.S.C. § 112 Para. 6. It will be apparent to those having skill in the art that changes may be made to the details of the above-described embodiments without departing from the underlying principles of the disclosure.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation to encompass all such modifications and equivalent structure as is permitted under the law.

What is claimed is:

1. A computer-implemented method for generating and dynamically applying a digital representation of items within a warehouse environment, the method comprising:
receiving an inbound shipping label pertaining to a box and an indication that the box is currently located at a first location within the warehouse environment;
generating a digital representation, based on the inbound shipping label, pertaining to:
a quantity of items within the box;
dimensions of the items within the box; and
weight of the items within the box;
determining a subset of work orders from a plurality of work orders to sort the respective ones of the items within the box into;
providing an indication of the sorted items and the subset of work orders;
sending item-specific labels to be printed based on association with the subset of work orders;
determining a type of carton label to be printed for respective ones of the subset of work orders, wherein a first type of carton label is a marketplace shipping label and a second type of carton label is a warehouse management system type of carton label; and
responsive to receiving an updated quantity of items within the box, updated dimensions of the items within the box, and updated weight of the items within the box,
updating the digital representation;
determining, based on the updated digital representation, that an additional box is to be added to the subset of work orders; and
providing instructions to route the respective ones of the items and the additional box towards a location in the warehouse environment designated for a truck being loaded for an outbound marketplace shipment.

2. A warehouse management system, comprising:
a handheld device, configured to:
receive input data from a warehouse associate within a warehouse environment;
provide the input data to a computing device;
responsive to reception of instructions from the computing device, provide the instructions to the warehouse associate; and
the computing device, configured to:
responsive to reception, via the handheld device, of an inbound shipping label pertaining to a box and an indication that the box is currently located at a first location within the warehouse environment, retrieve data, based on the inbound shipping label, pertaining to:
a quantity of items within the box;
dimensions of the items within the box; and
weight of the items within the box;
determine a subset of work orders from a plurality of work orders to sort the respective ones of the items within the box into;
provide an indication of the sorted items and the subset of work orders to the handheld device;
send item-specific labels to be printed based on association with the subset of work orders;
determine a type of carton label to be printed for respective ones of the subset of work orders, wherein a first type of carton label is a marketplace shipping label and a second type of carton label is a warehouse management system type of carton label;
organize the respective ones of the items into an outbound marketplace shipment; and
send routing instructions to the handheld device, wherein the routing instructions provide instructions to route the respective ones of the items towards a location in the warehouse environment designated for a truck being loaded for the outbound marketplace shipment.

3. The warehouse management system of claim 2, wherein, to determine the subset of work orders to sort the respective ones of the items within the box into, the computing device is configured to:
verify that the quantity of items within the box matches a ground truth number of items that are expected to be present within the box;
select the subset of work orders from the plurality of work orders based on critical inventory data of the warehouse environment; and
sort the respective ones of the items into the subset of work orders to match fulfillment requests.

4. The warehouse management system of claim 3, wherein, verify that the quantity of items within the box matches the ground truth number of items that are expected to be present within the box, the computing device is further configured to:
provide the ground truth number of items to the handheld device; and
receive a confirmation, via the handheld device, that matches a ground truth number of items that are expected to be present within the box.

5. The warehouse management system of claim 3, wherein, to determine the subset of work orders to sort the respective ones of the items within the box into, the computing device is further configured to:
generate an additional work order to match the fulfillment requests; and
sort the respective ones of the items into the subset of work orders and the additional work order.

6. The warehouse management system of claim 2, wherein the computing device is further configured to:
responsive to the determination of the subset of work orders to sort the respective ones of the items within the box into, generate preparation instructions pertaining to the sorted items within the corresponding work orders; and
provide the indication of the sorted items and the subset of work orders to the handheld device, in addition to the preparation instructions.

7. The warehouse management system of claim 2, wherein, to determine the type of carton label to be printed for the respective ones of the subset of work orders, the computing device is configured to:
determine that there are no unassigned digital representations for the subset of work orders; and
cause the warehouse management system type of carton label to be printed.

8. The warehouse management system of claim 2, wherein, to determine the type of carton label to be printed for the respective ones of the subset of work orders, the computing device is configured to:
determine that there is an unassigned digital representation for the subset of work orders;
determine that the unassigned digital representation matches the quantity of items within the box;
determine that the inbound shipping label has been printed on the unassigned digital representation; and
cause the marketplace shipping label to be printed.

9. The warehouse management system of claim 2, wherein, to determine the type of carton label to be printed for the respective ones of the subset of work orders, the computing device is configured to:
determine that there is an unassigned digital representation for the subset of work orders;
determine that the unassigned digital representation matches the quantity of items within the box;
determine that the inbound shipping label has not been printed on the unassigned digital representation; and
cause the warehouse management system type of carton label to be printed.

10. The warehouse management system of claim 2, wherein, to determine the type of carton label to be printed for the respective ones of the subset of work orders, the computing device is configured to:
determine that there is an unassigned digital representation for the subset of work orders;
determine that the unassigned digital representation does not match the quantity of items within the box, wherein the unassigned digital representation has a larger quantity than the quantity of items within the box;
assign the unassigned digital representation to a transient box;
cause an additional digital representation to store remaining ones of the quantity of items; and
cause the marketplace shipping label to be printed.

11. The warehouse management system of claim 2, wherein, to determine the type of carton label to be printed for the respective ones of the subset of work orders, the computing device is configured to:
determine that there is an unassigned digital representation for the subset of work orders;
determine that the unassigned digital representation does not match the quantity of items within the box, wherein the unassigned digital representation has a smaller quantity than the quantity of items within the box;
assign the unassigned digital representation to a transient box;
cause a quantity of items within the transient box to be increased; and
cause the marketplace shipping label to be printed.

12. The warehouse management system of claim 2, wherein, to determine the type of carton label to be printed for the respective ones of the subset of work orders, the computing device is configured to:
determine that there is an unassigned digital representation for the subset of work orders;
determine that the unassigned digital representation does not match the quantity of items within the box, wherein the unassigned digital representation has a smaller quantity than the quantity of items within the box;
assign the unassigned digital representation to a transient box;
cause the smaller quantity of items within the unassigned digital representation to be increased; and
cause the marketplace shipping label to be printed.

13. The warehouse management system of claim 2, wherein, to organize the respective ones of the items into the outbound marketplace shipment, the computing device is configured to:
determine a frequency of outbound marketplace shipment generations;
optimize groupings of items pertaining to the outbound marketplace shipment generations; and
store the marketplace shipping label.

14. The warehouse management system of claim 2, wherein the computing device is further configured to:
receive a notification that a shipping truck has arrived at the warehouse environment; and
cause the inbound shipping label to be printed.

15. The warehouse management system of claim 14, wherein the computing device is further configured to:
responsive to the reception of the notification that the shipping truck has arrived, link the inbound shipping label to a purchase order; and
generate a shipment pre-creation statement.

16. The warehouse management system of claim 15, wherein, to generate the shipment pre-creation statement, the computing device is configured to:
determine that the plurality of work orders correspond to the purchase order;
determine that there is a case pack quantity within a product catalog; and
determine a shipment quantity associated with the case pack quantity.

17. The warehouse management system of claim 16, wherein, to determine the shipment quantity, the computing device is configured to calculate a minimum of pack slip quantities and remaining work order quantities.

18. The warehouse management system of claim 17, wherein:
to generate the shipment pre-creation statement, the computing device is configured to generate a digital representation, wherein the digital representation represents a number of cartons to be received for the plurality of work orders; and
to generate the digital representation, the computing device is configured to divide the calculated minimum of pack slip quantities by the case pack quantity.

19. The warehouse management system of claim 18, wherein, responsive to the generation of the digital representation, the computing device is configured to:
cause inbound shipment labels per box to be printed; and
provide additional instructions to the handheld device, wherein the additional instructions comprise an indication to load a conveyor that transmits the box to the first location within the warehouse environment.

20. A computer-implemented method for managing a warehouse environment, the method comprising:
receiving an inbound shipping label pertaining to a box and an indication that the box is currently located at a first location within the warehouse environment, retrieve data, based on the inbound shipping label, pertaining to a quantity of items within the box;
determining a subset of work orders from a plurality of work orders to sort the respective ones of the items within the box into;
providing an indication of the sorted items and the subset of work orders to a handheld device;
sending item-specific labels to be printed based on association with the subset of work orders;
determining a type of carton label to be printed for respective ones of the subset of work orders, wherein a first type of carton label is a marketplace shipping label and a second type of carton label is a warehouse management system type of carton label;
organizing the respective ones of the items into an outbound marketplace shipment; and
sending routing instructions to the handheld device, wherein the routing instructions provide instructions to route the respective ones of the items towards a location in the warehouse environment designated for a truck being loaded for the outbound marketplace shipment.
